(19) United States
(12) Patent Application Publication
(10) Pub. No.: US 2017/0289251 A1
(43) Pub. Date: Oct. 5, 2017

(54) DATA PROCESSING METHOD

(71) Applicant: FUJITSU LIMITED, Kawasaki-shi (JP)

(72) Inventors: Koji KURIHARA, Kawasaki (JP); Koichiro YAMASHITA, Hachioji (JP); Takahisa SUZUKI, Yokohama (JP); Hiromasa YAMAUCHI, Kawasaki (JP); Toshiya OTOMO, Kawasaki (JP); Naoki ODATE, Akiruno (JP)

(73) Assignee: FUJITSU LIMITED, Kawasaki-shi (JP)

(21) Appl. No.: 15/630,149

(22) Filed: Jun. 22, 2017

Related U.S. Application Data
(62) Division of application No. 14/085,131, filed on Nov. 20, 2013.
Application No. 14/085,131 is a continuation of application No. PCT/JP2011/061675, filed on May 20, 2011.

(51) Int. Cl. H04L 29/08; H04W 8/00; H04L 12/26; G06F 9/50

(52) U.S. Cl. CPC H04L 67/1097; H04L 43/00; G06F 9/5072; H04W 8/005

(57) ABSTRACT

A data processing method is executed by a processor, and includes detecting an addition request to add a first device to a first group that includes a plurality of devices; registering the first device into a main group in which devices of the first group are registered, the first device being registered when the first device does not belong to a second group that is different from the first group; registering the first device into a subgroup, when the first device belongs to the second group; and performing by the devices registered in the main group, distributed processing that includes a plurality of tasks.

### CROSS REFERENCE TO RELATED APPLICATIONS

This application is a divisional of U.S. application Ser. No. 14/085,131 filed Nov. 20, 2013, which is a continuation application of International Application PCT/JP2011/061675, filed on May 20, 2011 and designating the U.S., the entire contents of which are incorporated herein by reference.

### FIELD

The embodiment discussed herein is related to a data processing method.

### BACKGROUND

Conventionally, computation processing for which high processing capacity is demanded when processing is performed by one terminal is has a large processing volume. When such computation processing is executed, by assigning processes included in the computation processing to multiple terminals and performing parallel processing, the computation processing can executed even if the performance of each of the terminals is low. Hereinafter, computation processing subject to parallel processing is referred to as “distributed processing”. Examples of distributed processing include scientific technological calculations and rendering applications such as meteorological simulations.

Among a group of terminals performing distributed processing is a master terminal that controls the distributed processing. The master terminal controls slave terminals in the group to perform the distributed processing. For example, from among multiple processes included in the distributed processing, the master terminal assigns a process to a slave terminal and collects process results from the slave terminal to perform the distributed processing.

A related conventional technology is a technology that compresses the data of point of sale (POS) apparatuses that are connected by a network, and retains the data at each of the POS apparatuses as backup data (see, for example, Japanese Laid-Open Patent Publication No. 2003-67232). Another technology lends based on load information of a group of central processing units (CPU), the processing capacity of a CPU for processing at another CPU (see, for example, Japanese Laid-Open Patent Publication No. H8-77026). Yet another technology prepares internally a memory area for saving processing information of a process that is interrupted (see, for example, Japanese Laid-Open Patent Publication No. S64-76228).

Nonetheless, with the conventional technologies, terminals included among the group performing distributed processing are assumed to be fixed at an installation site and are not assumed to be mobile terminals. Therefore, in a case where the group of terminals that can communicate with the master terminal changes dynamically consequent to the terminals being mobile, a problem arises in that terminals to be registered in a group to perform the distributed processing cannot be selected from the terminal group and distributed processing cannot be performed among the mobile terminals.

Further, in a case where distributed processing is performed by terminals of a group of mobile terminals, a problem arises in that if a terminal already belonging to another group is included in a given group, the terminal is assigned processes from both groups, i.e., the load on the terminal increases.

In a case where a group has been formed, the group is dissolved after the distributed processing has ended since other distributed processing is to be performed. Therefore, for a terminal that already belonged to another group, the terminal does not belong to any group after the distributed processing ends, inviting drops in the efficiency of the distributed processing.

### SUMMARY

According to an aspect of an embodiment, a data processing method is executed by a processor, and includes detecting an addition request to add a first device to a first group that includes a plurality of devices; registering the first device into a main group in which devices of the first group are registered, the first device being registered when the first device does not belong to a second group that is different from the first group; registering the first device into a subgroup, when the first device belongs to the second group; and performing by the devices registered in the main group, distributed processing that includes a plurality of tasks.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting slave terminal registration, by a master terminal, to a group that is to perform distributed processing;

FIG. 2 is a diagram depicting an example of a network system according to an embodiment;

FIG. 3 is a block diagram of a hardware example of a terminal MT according to the embodiment;

FIG. 4 is a diagram depicting the contents of a main group information DB 400;

FIG. 5 is a diagram depicting the contents of a subgroup information DB 500;

FIG. 6 is a diagram depicting of the contents of a master terminal information DB 600;

FIG. 7 is a block diagram of a hardware example of a base station BS according to the embodiment;

FIG. 8 is a diagram depicting the contents of a group information DB 800;

FIG. 9 is a block diagram of an example of a functional configuration of the master terminal MT;

FIG. 10 is a block diagram of a functional configuration of a slave terminal MT;

FIG. 11 is a flowchart of a registration process 1 of slave terminals MT performed by the master terminal MT;

FIG. 12 is a flowchart of a registration process 2 of slave terminals MT performed by the master terminal MT;

FIG. 13 is a flowchart of a response process performed by the slave terminal MT that has received group affiliation confirmation notification transmitted by the master terminal MT;

FIG. 14 is a flowchart of a terminal MT position information transmission process performed by the base station BS;

FIG. 15 is a flowchart of a group information registration process performed by the base station BS;

FIG. 16 is a diagram depicting group reformation in a case where a new terminal MT enters a communication cell C of the base station BS;

FIG. 17 is a flowchart of a group reformation process performed by the master terminal MT;

FIG. 18 is a diagram depicting group reformation in a case where a slave terminal MT in a group has completed execution of an assigned process;

FIG. 19 is a flowchart of a group registration deletion process performed by the master terminal MT;

FIG. 20 is a flowchart of a response process by the slave terminal MT that receives registration deletion notification transmitted by the master terminal MT;

FIG. 21 is a flowchart of a response process performed by the slave terminal MT that receives process completion notification from the master terminal MT;

FIG. 22 is a diagram depicting group reformation in a case where the communication state between the master terminal MT and a terminal MT in the group thereof becomes poor;

FIG. 23 is a flowchart of a group registration deletion process performed by the master terminal MT;

FIG. 24 is a diagram depicting the start of execution of distributed processing of a main group by a terminal MT that is executing distributed processing of a subgroup;

FIG. 25 is a flowchart of a start process of execution of distributed processing of the main group;

FIG. 26 is a flowchart of a data collection process performed by the master terminal MT of the subgroup;

FIG. 27 is a diagram depicting a process request by the master terminal MT to a slave terminal MT of the subgroup;

FIG. 28 is a flowchart of a processing-request process performed by the master terminal MT to request a slave terminal MT of the subgroup to perform distributed processing; and

FIG. 29 is a flowchart of a processing-request accepting process performed by a slave terminal MT.

### DESCRIPTION OF EMBODIMENTS

An embodiment of a data processing method will be described in detail with reference to the accompanying drawings. According to the data processing method, a given master terminal that controls distributed processing registers slave terminals that are not assigned distributed processing by another master terminal, into a main group of terminals that are primarily assigned distributed processing by the given master terminal. The given master terminal further registers slave terminals that are assigned distributed processing by another master terminal, into a subgroup of terminals that are assigned distributed processing ad interim by the given master terminal.

Thus, the master terminal assigns the distributed processing to terminals registered in the main group, thereby enabling efficient distributed processing to be executed. Further, when a process that has yet to be executed is present and a terminal registered in the subgroup is in an idle state, the master terminal assigns distributed processing to the terminal ad interim, thereby enabling efficient distributed processing to be performed. When the communication state of a terminal registered in the main group deteriorates consequent to movement of the terminal and a terminal registered in the subgroup is in an idle state, the master terminal reassigns the distributed processing to the subgroup ad interim, enabling the distributed processing to be continued.

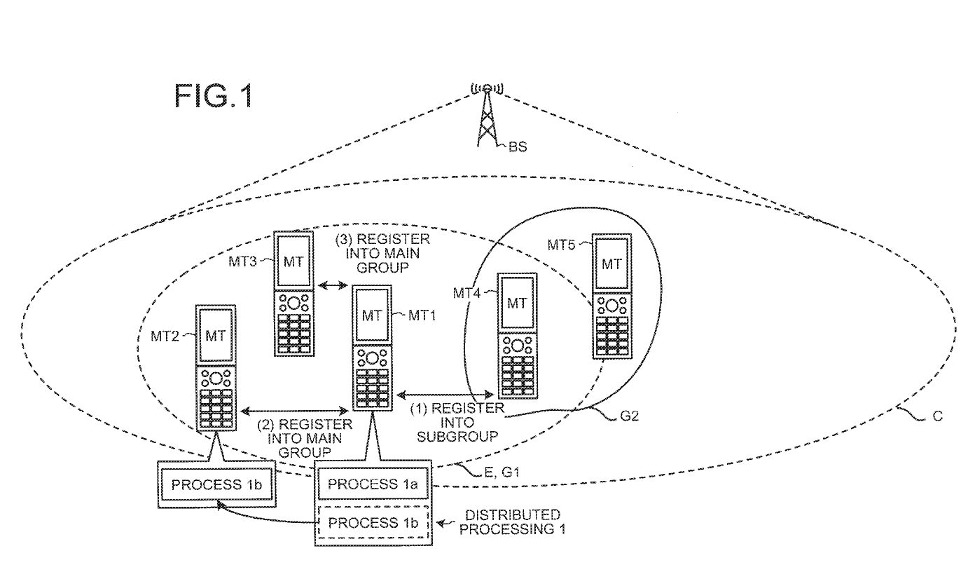

Slave terminal registration, by the master terminal, to a group that is to perform distributed processing will be described with reference to FIG. 1.

FIG. 1 is a diagram depicting slave terminal registration, by the master terminal, to a group that is to perform distributed processing. As depicted in FIG. 1, multiple terminals MT, i.e., mobile terminals (in the example, five, including terminals MT1 to MT5) are present within a communication cell C of a base station BS. A terminal MT is a mobile communication apparatus and may be, for example, a mobile telephone, a personal digital assistant (PDA), a smartphone, a notebook personal computer (PC), a game device, and the like.

Among the terminals MT in the communication cell C of the base station BS is a master terminal MT that controls the execution of the distributed processing, which includes multiple processes. Here, as an example, the terminals MT1 and MT5 are regarded as master terminals MT. Further, among the terminals MT in the communication cell C of the base station BS are slave terminals MT that perform the assigned distributed processing under the control of the master terminals MT. As an example, the terminals MT2 to MT4 are regarded as slave terminals MT.

In FIG. 1, the master terminal MT5 forms a group G2 that includes the master terminal MT5 and the slave terminal MT4. On the other hand, the master terminal MT1 has not yet formed a group G1. When the master terminal MT1 forms the group G1, the master terminal MT1 separates the group G1 into a main group and a subgroup. Here, the main group is a group to which slave terminals MT that regularly accept process requests from the master terminal MT1 are registered. The subgroup is a group to which slave terminals MT that accept process requests ad interim from the master terminal MT1 are registered.

A slave terminal registered in the main group is a slave terminal that does not belong to another group. Thus, the master terminal MT1 regularly requests the slave terminal MT to perform processing, enabling efficient distributed processing.

A slave terminal registered in the subgroup is a slave terminal MT that already belongs to another group. Thus, the master terminal MT1 prevents increase of the load on the slave terminal by not making process requests as far as possible to the slave terminal. However, when the CPU of the slave terminal registered in the subgroup enters an idle state, such as when the distributed processing of the other group has ended, or when the distributed processing of the other group has been interrupted, the master terminal MT1 requests processing ad interim, thereby facilitating efficient distributed processing.

In FIG. 1, the master terminal MT1 has distributed processing 1 that includes a process 1a and a process 1b. In this example, the process 1a and the process 1b are respectively a series of operations and may be for example, a single task or a group of tasks. Further, the process 1a and the process 1b may be independent processes, or processes having an exclusive relationship where one process under execution is interrupted by the other process. An exclusive relationship is, for example, a relationship in which the process results of one process is referred to by the other process.

In this example, the master terminal MT1 acquires from the base station BS, position information of the terminals MT1 to MT5, refers to the acquired position information, and detects slave terminals MT in an ad hoc communication cell E of the master terminal MT1. Ad hoc communication is a communication scheme in which each terminal MT has a function of relaying communication with other terminals MT that are in the communication cell of the terminal MT, whereby communication with a terminal MT that is not in the communication cell of the terminal MT is enabled.

The master terminal MT1, based on whether a detected slave terminal MT belongs to another group, registers the detected slave terminal into the main group or the subgroup of the group G1 to perform distributed processing. The master terminal MT1 assigns the distributed processing 1 to the master terminal MT1 and the slave terminals MT registered in the main group of the group G1 and performs the distributed processing 1 by parallel processing.

(1) For example, the master terminal MT1 refers to the position information acquired from the base station BS and upon detecting the slave terminal MT4, starts a registration process of registering the slave terminal MT4 to the main group or the subgroup. In this example, the slave terminal MT4 belongs to the group G2 of the master terminal MT5 and the CPU of the slave terminal MT4 is used for distributed processing by process requests primarily from the master terminal MT5.

Therefore, the master terminal MT1 determines that the slave terminal MT4 is unable to regularly accept process requests from the master terminal MT1 and registers the slave terminal MT4 into the subgroup.

(2) Next, the master terminal MT1 refers to the position information acquired from the base station BS and upon detecting the slave terminal MT2, starts a registration process of registering the slave terminal MT2 into the main group or the subgroup. In this example, the slave terminal MT2 does not belong to the group 2 of the master terminal MT5 and the CPU of the slave terminal MT2 can be used for the distributed processing 1 by process requests from the master terminal MT1.

Therefore, the master terminal MT1 determines that the slave terminal MT2 can regularly accept process requests from the master terminal MT1 and registers the slave terminal MT2 into the main group.

(3) The master terminal MT1 refers to the position information from the base station BS and upon detecting the slave terminal MT3, starts a registration process of registering the slave terminal MT3 into the main group or the subgroup. In this example, the slave terminal MT3 does not belong the group 2 of the master terminal MT5 and the CPU of the slave terminal MT2 can be used for the distributed processing 1 by process requests from the master terminal MT1.

Therefore, the master terminal MT1 determines that the slave terminal MT3 can regularly accept process requests from the master terminal MT1 and registers the slave terminal MT3 into the main group.

However, since the number of processes included in the distributed processing 1 is two, parallel processing is possible with the master terminal MT1 and the slave terminal MT2 registered in the main group. Therefore, the master terminal MT1 determines that even if the slave terminal MT3 is registered into main group, there is no process to assign the slave terminal MT3 and thus, may register the slave terminal MT3 into the subgroup.

The master terminal MT1 forms the group G1 that is to perform the distributed processing 1, requests the slave terminal MT2 registered in the main group to perform the process 1b, executes the process 1a and thus, executes the distributed processing 1. In this manner, the master terminal MT1 requests the slave terminals MT2 and MT3, which do not belong to another group, to perform processes, enabling efficient execution of the distributed processing 1.

Here, the communication of data between the master terminal MT1 and the slave terminal MT2 is assumed to have become difficult consequent to movement of the slave terminal MT2. In this case, the master terminal MT1 may use the slave terminal MT3 of the main group and the slave terminal MT4 of the subgroup to continue the execution of the distributed processing. In this manner, the master terminal MT1 is able to form groups that can execute distributed processing according to variations in the communication state consequent to the terminals MT that are included in the group, being mobile.

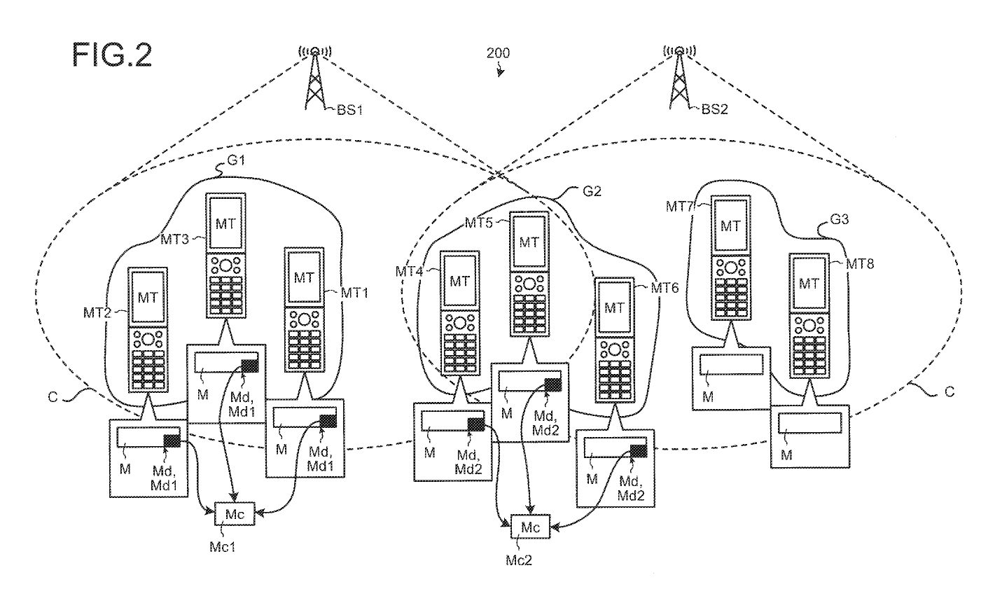

FIG. 2 is a diagram depicting an example of a network system according to the embodiment. As depicted in FIG. 2, a network system 200 includes terminals MT1 to MT8 and the base stations BS1 and BS2. In the network system 200, the terminals MT1 to MT8 are connected via the base stations BS1 and BS2.

The terminals MT1 to MT8 are wireless mobile communication apparatuses that communicate with other terminals MT. Among the terminals MT1 to MT8, the terminals MT1, MT5, and MT8 are master terminals MT. On the other hand, among the terminals MT1 to MT8, the terminals MT2 to MT4, MT6, and MT7 are slave terminals MT.

Among the slave terminals MT connected to the base stations BS1 and BS2 to which the master terminals MT1, MT5, and MT8 are connected, the master terminals MT1, MT5, and MT8 each registers into a respective group thereof, slave terminals MT that are within an ad hoc communication range.

In other words, the master terminals MT and the slave terminals MT perform ad hoc communication by multi-hop communication. In the ad hoc communication, modules for ad hoc communication are prepared for each communication destination terminal MT and communication is performed. Here, although the master terminals MT and the slave terminals MT perform ad hoc communication, communication may be via the base stations BS.

For example, the master terminal MT1 registers the slave terminals MT2 and MT3 into the group G1. Further, the master terminal MT5 registers the slave terminals MT4 and MT6 into the group G2. The master terminal MT8 registers the slave terminal MT7 into a group G3 of slave terminals MT.

Among the master terminals MT, a terminal MT may be present that can communicate with multiple base stations like the master terminal MT5. Further, among the master terminals MT, a master terminal MT may be present that can become the slave terminal MT of another master terminal MT.

Here, the terminals MT1 to MT3 in the group G1 respectively have memory M. The memory M of each of the terminals MT1 to MT3 of the group G1 has a distributed shared memory area Md1. The distributed shared memory area Md1 is an area that can be accessed by the terminals MT of the group G1.

Here, the size of the distributed shared memory area Md1 that the terminals MT1 to MT3 set in the memory M is a size that does not hamper operation of the terminal MT, e.g., 10 percent or less of the memory M of the terminal MT. As a result, for the group G1, virtual shared memory Mc1, which is an aggregate of the distributed shared memory areas Md1 of the terminals MT1 to MT3, is created. Each of the terminals MT1 to MT3 of the group G1 uses the shared memory Mc1 created in such a manner, to save process results and makes effective use of the memory M thereof.

For example, when the terminals MT1 to MT3 interrupt distributed processing that is under execution and respectively execute a new process, the terminals MT1 to MT3 save intermediate process results of the distributed processing to the shared memory Mc1 such that the intermediate process results are not over written by the process results of the new processes. When the interrupted distributed processing is resumed, the terminals MT1 to MT3 recover the saved intermediate process results and resume the distributed processing.

Similarly, for the group G2, shared memory Mc2 is created from distributed shared memory areas Md2. On the other hand, a group may be present that does not create shared memory Mc such as the group G3. Further, among the terminals MT1 to MT6, a terminal MT maybe present that does not have a distributed shared memory area Md. The distributed shared memory areas Md of the respective terminals MT may differ in size.

The network system 200 may include a terminal MT that is fixed at an installation site. Such a terminal MT is, for example, a personal computer (PC), server, and the like. Further, other than base stations, the network system 200 may include a gateway.

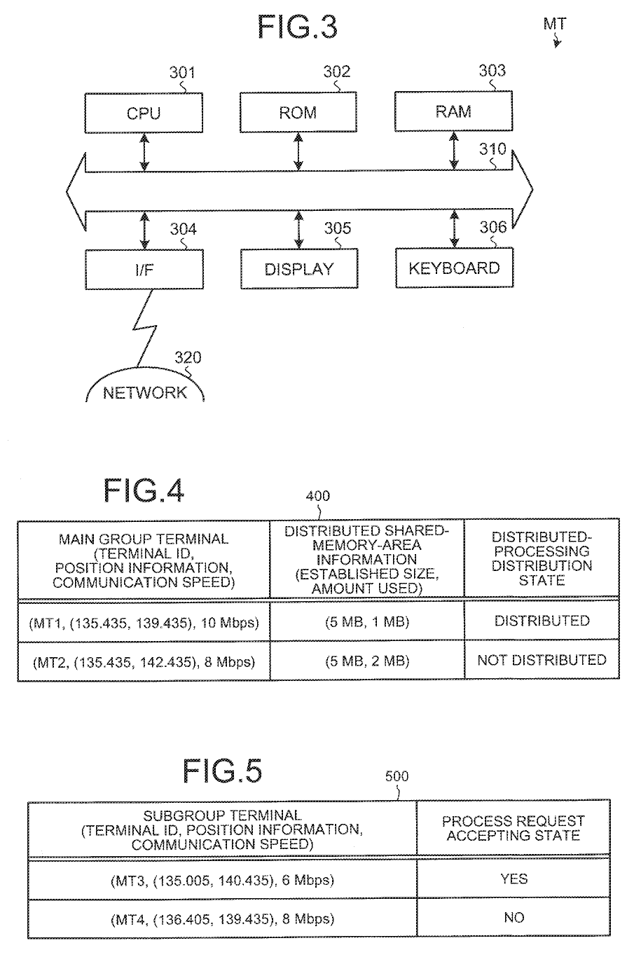

With reference to FIG. 3, a hardware example of the terminal MT according to the embodiment will be described. Here, terminal MT is a terminal MT that becomes a master terminal MT or a slave terminal MT, e.g., the terminals MT1 to MT8.

FIG. 3 is a block diagram of a hardware example of the terminal MT according to the embodiment. As depicted in FIG. 3, the terminal MT includes a CPU 301, read-only memory (ROM) 302, random access memory (RAM) 303, an interface (I/F) 304, a display 305, and a keyboard 306, respectively connected by a bus 310.

The CPU 301 governs overall control of the terminal MT. The ROM 302 stores programs such as boot program. The RAM 303 is used as work area of the CPU 301. The memory M depicted in FIG. 2, herein, corresponds to the RAM 303.

When the terminal MT is a master terminal MT, the RAM 303 stores a main group information database (DB) and a subgroup information DB. On the other hand, when the terminal MT is a slave terminal MT, the RAM 303 stores a master terminal information DB.

The I/F 304 controls the transmission and reception of radio waves with respect to the base station BS, is connected to a network 320 such as a local area network (LAN), a wide area network (WAN) and the Internet, and is connected to other apparatus via the network 320. The I/F 304 administers an internal interface with the network 320, and controls the input and output of data with respect to external apparatuses. The I/F 304, by multi-hop communication, transmits data to and receives data from other apparatuses in the communication cell E.

The display 305 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 305. The keyboard 306 includes, for example, keys for inputting letters, numerals, and various instructions and performs the input of data. Alternatively, a touch-panel-type input pad or numeric keypad, etc. may be adopted.

With reference to FIG. 4, the contents of a main group information DB 400 that is stored in the RAM 303, when the terminal MT depicted in FIG. 3 is a master terminal MT will be described.

FIG. 4 is a diagram depicting the contents of the main group information DB 400. As depicted in FIG. 4, the main group information DB 400 has a main group terminal field, a distributed shared-memory-area information field, and a distributed-processing distribution state field, for each slave terminal MT in the main group, forming a record for each slave terminal MT.

The main group terminal field stores information related to a slave terminal MT registered in the main group. Information related to the slave terminal MT includes a terminal identification (ID), position information, and communication speed.

The terminal ID is identifier information that uniquely identifies the slave terminal MT. For example, when the slave terminal MT is a mobile telephone, the International Mobile Subscriber Identity (IMSI) given to the Subscriber Identity Module (SIM) card may be used as the terminal ID.

However, when the master terminal MT registers the slave terminal MT into the main group, the master terminal MT may append to the slave terminal MT and employ as the terminal ID, local identifier information that enables unique identification of the slave terminal MT only at the master terminal MT.

The position information is position information that indicates the current position of the slave terminal MT. For example, the position information may be coordinates determined by a global positioning system (GPS). In FIG. 4, the coordinates determined by GPS are information of latitude and longitude.

The communication speed indicates the volume of data transmitted between the master terminal MT and the slave terminal MT per unit time. For example, the communication speed is in units of bits per second (bps).

The distributed shared-memory-area information field stores information of the distributed shared memory area Md in the slave terminal MT. The information of the distributed shared memory area Md is the established size of and the amount used of the distributed shared memory area Md at the slave terminal MT.

The distributed-processing distribution state field stores indication of whether a process among distributed processing has been assigned to the slave terminal MT consequent to a process request from the master terminal MT. The distributed-processing distribution state field stores, for example, “distributed”, if a process has been assigned consequent to a process request from the master terminal MT.

On the other hand, if the master terminal MT has not made a process request or if process results for a process requested by the master terminal MT have been returned, the distributed-processing distribution state field stores, for example, “not distributed”.

With reference to FIG. 5, the contents of a subgroup information DB 500 that is stored in the RAM 303, when the terminal MT depicted in FIG. 3 is a master terminal MT will be described.

FIG. 5 is a diagram depicting the contents of the subgroup information DB 500. As depicted in FIG. 5, the subgroup information DB 500 has a subgroup terminal field and a process request accepting state field, for each slave terminal MT in the subgroup, forming a record for each slave terminal MT.

The subgroup terminal field stores information of the slave terminal MT registered in the subgroup. The information of slave terminal MT stored in the subgroup terminal field is the terminal ID, the position information and the communication speed thereof; and is the same type of information as the information of the slave terminal MT stored in the main group terminal field depicted in FIG. 4 and therefore, detailed description is omitted hereinafter.

The process request accepting state field stores indication of whether distributed processing of the subgroup can be executed consequent to a process request from the master terminal MT. For example, if the distributed processing of another group has been suspended or if the CPU 301 has entered an idle state, the process request accepting state field stores indication that the distributed processing of the group can be executed (in FIG. 5, “YES”). On the other hand, if the distributed processing of another group is under execution, or the CPU 301 is not in an idle state, indication that the distributed processing of the group cannot be executed is stored (in FIG. 5, “NO”).

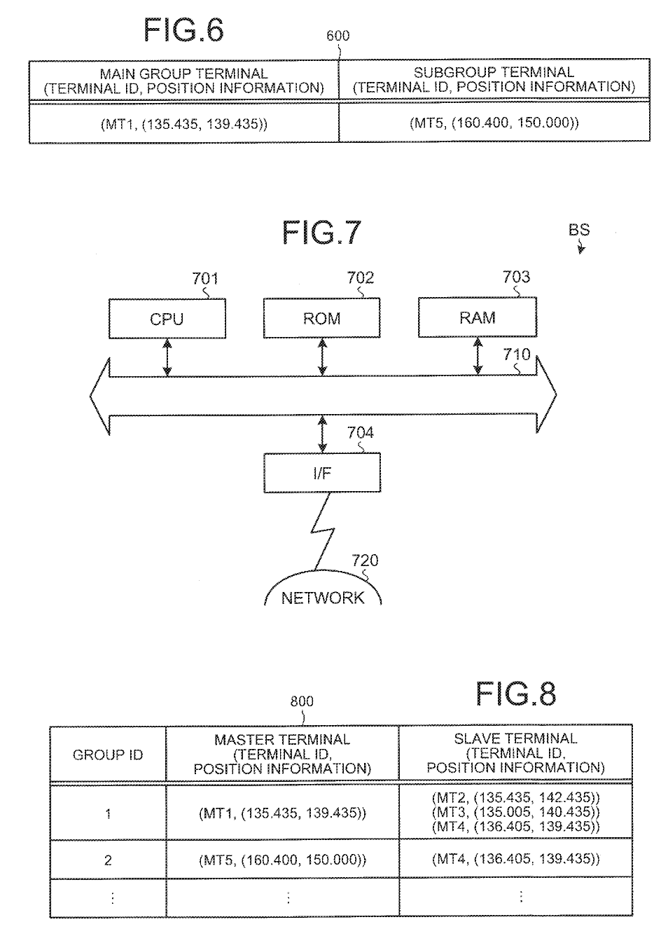

With reference to FIG. 6, the contents of a master terminal information DB 600 that is stored in the RAM 303, when the terminal MT depicted in FIG. 3 is a slave terminal MT will be described.

FIG. 6 is a diagram depicting of the contents of the master terminal information DB 600. As depicted in FIG. 6, the master terminal information DB 600 has a main group master terminal field and a subgroup master terminal field, forming a record each time a terminal MT is registered by a master terminal MT, into a main group or a subgroup.

The main group master terminal field stores information of the master terminal MT that registered the terminal MT into a main group. The information of the master terminal MT is the terminal ID and the position information thereof, and is the same type of information as the information of the slave terminal MT stored in the main group terminal field depicted FIG. 4 and therefore, detailed description is omitted hereinafter.

The subgroup master terminal field stores information of the master terminal MT that registered the terminal MT into the subgroup. The information of the master terminal MT is the terminal ID and the position information thereof, and is the same information as the information of the slave terminal MT stored in the main group terminal field depicted FIG. 4 and therefore, detailed description is omitted hereinafter.

Although only one master terminal MT registers the terminal MT into a main group, multiple master terminals MT may register the terminal MT into a subgroup.

With reference to FIG. 7, hardware of the base station according to the embodiment will be described. Here, the base station, for example, is the base station BS described above.

FIG. 7 is a block diagram of a hardware example of the base station according to the embodiment. As depicted in FIG. 7, the base station BS includes a CPU 701, ROM 702, RAM 703, and an I/F 704, respectively connected by a bus 710.

The CPU 701 governs overall control of the base station BS. The ROM 702 stores programs such as a boot program. The RAM 703 is used as a work area of the CPU 701.

The I/F 704 controls the transmission and reception of radio waves with respect to the base station BS, is connected to a network 720 such as a LAN, a WAN and the Internet, and is connected to other apparatuses via the network 720. The I/F 704 administers an internal interface with the network 720, and controls the input and output of data with respect to external apparatuses.

With reference to FIG. 8, the contents of a group information DB 800 that is stored in the RAM 703 depicted in FIG. 7 will be described.

FIG. 8 is a diagram depicting the contents of the group information DB 800. As depicted in FIG. 8, the group information DB 800 has a group ID field, a master terminal field, and a slave terminal field, forming a record each time group information is received from the master terminal MT.

The group ID field stores identifier information (group ID) that uniquely identifies the group formed by the master terminal MT that is present in the communication cell C of the base station BS. The base station BS may assign a number when the group information is received from the master terminal MT, and employ the assigned number as the group ID. Further, the terminal ID of the master terminal MT that formed the group may be employed as the group ID.

The master terminal field stores information of the master terminal MT that formed the group indicated by the group ID. The information of the master terminal MT is the terminal ID and the position information thereof; and is the same type of information as the information of the slave terminal MT stored in the main group terminal field depicted in FIG. 4 and therefore, detailed description is omitted hereinafter.

The slave terminal field stores information of the slave terminals MT registered in the group indicated by the group ID. The information of the slave terminals MT is the terminal ID and the position information thereof; and is the same type of information as the information of the slave terminal MT stored in the main group terminal field depicted in FIG. 4 and therefore, detailed description is omitted hereinafter.

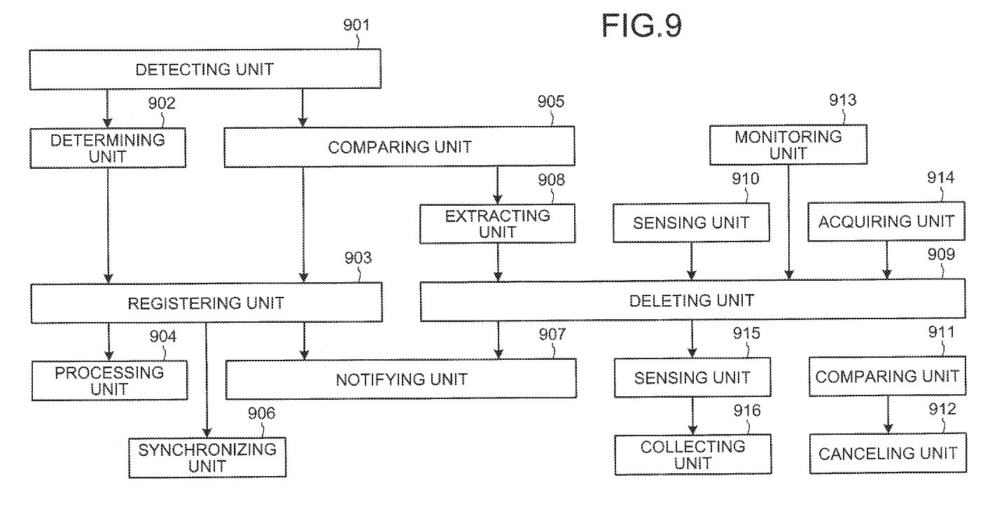

An example of a functional configuration of the master terminal MT will be described. FIG. 9 is a block diagram of an example of a functional configuration of the master terminal MT. The master terminal MT includes a detecting unit 901, a determining unit 902, a registering unit 903, a processing unit 904, a comparing unit 905, a synchronizing unit 906, a notifying unit 907, an extracting unit 908, a deleting unit 909, a sensing unit 910, a comparing unit 911, a canceling unit 912, a monitoring unit 913, an acquiring unit 914, a sensing unit 915, and a collecting unit 916. These functions (the detecting unit 901 to the collecting unit 916) forming a control unit are implemented, for example, by executing on the CPU 301, a program that is stored in a storage apparatus such as the ROM 302 and the RAM 303 depicted in FIG. 3, or via the I/F 304.

The detecting unit 901 has function of detecting a request to add a first device to a first group that includes multiple devices. Here, the first group that includes multiple devices is a group that performs distributed processing, e.g., the groups G1 and G2 described above. A request to add the first device is a request to register the first device into the first group and, for example, is a request to register into the first group, the first device that is near the first group and detected by the base station BS.

For example, the detecting unit 901 detects a request to register a slave terminal MT into the group of the master terminal MT, by receiving from the base station BS, notification of the presence of the slave terminal MT near the group. A request to register a terminal MT includes a terminal ID and position information, which are the contents of the main group terminal field in the main group information DB 400 or the contents of the subgroup terminal field in the subgroup information DB 500. Detected registration requests are stored to a storage area such as the RAM 303.

The determining unit 902 has a function of determining whether the first device belongs to a second group that is different from the first group. The second group is a group that performs distributed processing. For example, if the first group is the group G1 described above, the second group is the group G2 described above.

For example, the determining unit 902 acquires the contents of the master terminal information DB 600 that the terminal MT detected by the detecting unit 901 has, and determines whether the terminal MT belongs to another group. Determination results are stored to a storage area such as the RAM 303.

The registering unit 903 has a function of registering the first device into the main group in which the devices of the first group are registered, when the first device does not belong the second group that is different from the first group. The main group is a group in which slave terminals MT are registered that regularly accept process requests from the master terminal MT of the group.

For example, if the determining unit 902 determines that the detected slave terminal MT does not belong to another group, the registering unit 903 registers the detected slave terminal MT into the main group. In other words, the registering unit 903 registers into the main group information DB 400, a record for the detected slave terminal MT. Thus, a slave terminal MT that can regularly accept requests for distributed processing without performing the distributed processing of another group, can be registered into the main group.

The registering unit 903 has a function of registering the first device into the subgroup, when the first device belongs to the second group. The subgroup is a group in which slave terminals MT are registered that accept process requests from the master terminal MT of the group ad interim.

For example, if the determining unit 902 determines that the detected slave terminal MT belongs to another group, the registering unit 903 registers the detected slave terminal MT into the subgroup. In other words, the registering unit 903 registers into the subgroup information DB 500, a record for the detected slave terminal MT. Thus, slave terminals MT that are difficult to cause to execute the distributed processing despite issuing requests consequent to the slave terminals MT performing primarily parallel processing of the distributed processing of another group, can be excluded from the main group.

When a first count, which is the number of devices, is greater than or equal to a second count, which is the number of tasks, the registering unit 903 has a function of registering a second device into the subgroup. The first count is the number of terminals MT registered in the main group. A task is a single unit of processing, e.g., the processes 1a to 1d, 2a to 2c described above. The second count is the number of processes included in the distributed processing of the group. For example, when a comparison result obtained by the comparing unit 905 indicates that the number of terminals MT currently registered in the main group is greater than or equal to the number of processes included in the distributed processing, the registering unit 903 registers the slave terminal MT into the subgroup.

To perform the distributed processing as parallel processing, slave terminals MT of a number equal to the number of processes is favorable and when the slave terminals MT out number the processes, no process is present to assign to the excess slave terminals MT. Therefore, the excess slave terminals MT are registered into the subgroup and not into the main group, enabling some leeway to be established where the slave terminal MT can be registered into the main group of another group.

The registering unit 903 has a function of registering the second device into the main group, when the first count is less than the second count.

For example, when a comparison result obtained by the comparing unit 905 indicates that the number of terminals MT currently registered in the main group is less than the number of processes included in the distributed processing, the registering unit 903 registers the slave terminal MT into the main group. Thus, until the number of terminals MT registered in the main group is equal to the number of processes, slave terminals MT are registered into the main group, improving the efficiency of the parallel processing of the distributed processing.

The processing unit 904 has a function of performing by the devices registered in the main group, the distributed processing that includes multiple tasks. For example, the processing unit 904 assigns to the terminal MT thereof and to the slave terminals MT of the main group, processes that are included in the distributed processing, and causes parallel processing to be performed. Thus, even for distributed processing that handles a large volume of data, the execution period can be reduced. Further, to handle a large volume of data, by performing distributed processing for processing that demands high processing capacity when the processing is by one terminal 1, the processing can be performed even if the performance of each of the terminals MT is low.

The comparing unit 905 has a function of comparing the first count and the second count. For example, the comparing unit 905 compares the number of terminals MT currently registered in the main group and the number of processes included in the distributed processing, thereby enabling determination of whether the number of terminals MT currently registered in the main group is a sufficient number for assigning the processes included in the distributed processing. The number of terminals MT currently registered is obtained by counting the total number of records in the main group information DB 400. Comparison results are stored to a storage area such as the RAM 303.

The synchronizing unit 906 has a function of registering in the master terminal of the subgroup, synchronization requests that are for the first device and from devices included in the second group, when the first device is registered in the subgroup. For example, when a slave terminal MT that is executing the distributed processing of another group suspends the execution of the distributed processing consequent to a synchronization process of the other group, the synchronizing unit 906 registers whether an idle state has been entered. In other words, the synchronizing unit 906 updates the contents of the process request accepting state field in the subgroup information DB 500, enabling determination of whether the slave terminal MT of the subgroup can be requested to perform a process.

The notifying unit 907 has a function of notifying the base station of whether registration into the main group has been performed. The notifying unit 907 has a further function of notifying the base station of registration deletions in the main group. For example, the notifying unit 907 notifies the base station of the terminal ID of a slave terminal MT for which registration, no-registration, or registration deletion has been performed, enabling the group information DB 800 to be updated.

The extracting unit 908 has a function of extracting from the main group, a third device that is not assigned a task among multiple tasks. For example, the extracting unit 908 refers to the distributed-processing distribution state field in the main group information DB 400 and extracts from among the slave terminals MT registered in the main group information DB 400, a slave terminal MT to which no distributed-processing is assigned, enabling slave terminals MT that do not execute the distributed-processing to be extracted.

The deleting unit 909 has a function of deleting from the main group, registration of the third device to which no process is assigned, when the first count is greater than the second count. For example, when the number of terminals MT currently registered in the main group is greater than the number of processes included in the distributed processing, the deleting unit 909 deletes the registration of a slave terminal MT that is extracted by the extracting unit 908 and to which no process is assigned. For example, the deleting unit 909 deletes the corresponding record from the main group information DB 400. Thus, when slave terminals MT of a number exceeding the number of processes are registered, the registration of the excess slave terminals MT is deleted, enabling some leeway to be established where the slave terminal MT can be registered into the main group of another group.

The deleting unit 909 has a function of deleting from the main group, registration of a fourth device, when a deterioration in the communication capability of the fourth device is detected or task execution results of the fourth device are acquired. For example, when a deterioration in the communication capability of a slave terminal MT is detected by the monitoring unit 913, the deleting unit 909 deletes from the main group, the registration of a slave terminal MT whose communication capability has deteriorated. Thus, a slave terminal MT whose communication capability has deteriorated is excluded from the group, enabling the distributed processing to be stabilized and executed.

Further, for example, when intermediate process results are acquired by the acquiring unit 914, the deleting unit 909 deletes from the main group, a slave terminal MT for which intermediate process results have been acquired. For example, the deleting unit 909 deletes a corresponding record from the main group information DB 400. Thus, a slave terminal MT from which intermediate process results have been received, may be excluded from the group.

The deleting unit 909 has a function of not deleting from the main group, the registration of the third device, when a memory area that is set in the third device and part of the shared memory Mc that is shared by multiple devices, is being used. The memory area is an area in memory that is for saving intermediate process results of the distributed processing, e.g., the distributed shared memory area Md described above.

For example, even if a slave terminal MT has been extracted by the extracting unit 908, if data is detected in the distributed shared memory area Md by the sensing unit 910, the deleting unit 909 does not delete from the main group, the registration of the slave terminal MT, thereby enabling a situation to be prevented where intermediate process results cannot be collected consequent to the intermediate process results being saved in the distributed shared memory area Md of a slave terminal MT whose registration has been deleted from the main group.

The sensing unit 910 has a function of detecting use of the memory area of a slave terminal MT that has been extracted by the extracting unit 908 and to which no process has been assigned. For example, the sensing unit 910 refers to the amount used indicated in the distributed shared-memory-area information field of the main group information DB 400 and detects use of the distributed shared memory area Md of the slave terminal MT, thereby enabling detection of situations where intermediate process results of the distributed processing become unavailable consequent to a deletion of the registration of the slave terminal MT.

The comparing unit 911 has a function of comparing the size of the memory M used by a task among the tasks and the size of the shared memory Mc shared by the devices. For example, the comparing unit 911 compares the size of the memory M used by one task among the processes included in the distributed processing and the size of the shared memory Mc, thereby enabling determination of whether the shared memory Mc is of a size capable of saving the intermediate process results.

The canceling unit 912 has a function of canceling the setting of the shared memory Mc, when the size of the memory M used by a task is greater than the size of the shared memory Mc. For example, the canceling unit 912 refers to the comparison result obtained by the comparing unit 911 and if the size of the memory M used by a task among the processes included in the distributed processing is greater than the size of the shared memory Mc, the canceling unit 912 releases the distributed shared memory areas Md of the terminals MT in the group.

Thus, when the size of the shared memory Mc is not a size capable of saving the process results, the distributed shared memory areas Md are released, a work area of the slave terminals MT is established, and the processing efficiency is improved.

The monitoring unit 913 has a function of detecting a deterioration in the communication capability of the fourth device that is registered in the main group. For example, the monitoring unit 913 monitors the communication capability of a slave terminal MT, based on the strength of signals received from the slave terminal MT and detects deteriorations in the communication capability, thereby enabling the detection of slave terminals MT for which the transmission and reception of data becomes difficult.

The acquiring unit 914 has a function of acquiring process results of a task of the fourth device. For example, the acquiring unit 914 receives intermediate process results transmitted from a slave terminal MT that has suspended an assigned process. Thus, intermediate process results are collected, enabling the distributed processing to be continued.

The sensing unit 915 has a function of detecting use of a memory area of a slave terminal MT that is subject to registration deletion by the deleting unit 909. For example, the sensing unit 915 refers to the amount used indicated in the distributed shared-memory-area information field of the main group information DB 400 and detects use of the distributed shared memory area Md of a slave terminal MT. Thus, when the registration of a slave terminal MT is deleted, intermediate process results that are in the distributed shared memory area Md and have to be collected can be detected.

The collecting unit 916 has a function of collecting data in a memory area, when the memory area that is set in the fourth device and is a part of the shared memory Mc, is being used. For example, when the sensing unit 915 detects that the distributed shared memory area Md is being used, the collecting unit 916 collects the data in the distributed shared memory area Md. Thus, intermediate process results of the distributed processing are collected, enabling the distributed processing to be continued.

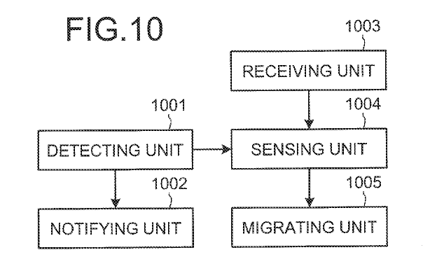

A functional configuration of the slave terminal MT will be described. FIG. 10 is a block diagram of a functional configuration of the slave terminal MT. The slave terminal MT includes a detecting unit 1001, a notifying unit 1002, a receiving unit 1003, a sensing unit 1004, and a migrating unit 1005. These functions (the detecting unit 1001 to the migrating unit 1005) forming a control unit are implemented, for example, by executing on the CPU 301, a program stored in a storage apparatus such as the ROM 302 and the RAM 303 depicted in FIG. 3, or via the I/F 304.

The detecting unit 1001 has a function of detecting a synchronization request that is to the first device and from the second device among the devices included in the first group. The first group is a group that performs distributed processing. The synchronization request is an interrupt request that is from the second device to the first device.

For example, the detecting unit 1001 detects a request to interrupt a process, when the respective processes executed by the terminal MT of the detecting unit 1001 and another terminal MT in the main group to which the terminal MT of the detecting unit 1001 belongs are processes subject to synchronization control. Thus, synchronization control is performed and the distributed processing is executed properly.

The detecting unit 1001 detects the start of execution of a task included in the distributed processing that is to be executed by the devices in the first group. For example, the detecting unit 1001 detects that a process has come about that is to be preferentially executed over the process assigned by the master terminal MT. Thus, when a process having a higher priority than the process assigned by the master terminal MT arises at the terminal MT of the detecting unit 1001, the high-priority process can be given priority and executed.

The first device is included in the second group that is different from the first group and is registered in the subgroup that corresponds to the main group in which devices that execute the distributed processing that includes multiple tasks are registered. In this case, to make registrations in the subgroup, the notifying unit 1002 has a function of notifying the device that manages the main group and the subgroup of a synchronization request. Here, the first device belongs to the main group and the subgroup.

For example, the notifying unit 1002 detects a synchronization request and notifies the master terminal MT of the subgroup that consequent to the interruption of a process, the CPU 301 has entered an idle state and thus, has become able to accept a process request from the subgroup. As a result, the CPU 301 that has entered an idle state is provided for the distributed processing of the subgroup, enabling the efficiency of the distributed processing of the subgroup to be improved.

The receiving unit 1003 has a function of receiving a deletion request from the first group. For example, the receiving unit 1003 receives a registration deletion request from the master terminal MT of the main group, enabling the deletion of registration from the main group to be learned of.

The receiving unit 1003 has a function of receiving an execution request for a task that is included in the distributed processing executed by the devices that are included in the first group. For example, the receiving unit 1003 receives a process request from the master terminal MT of the main group, enabling the execution of the distributed processing by the main group to be started.

The sensing unit 1004 has a function of detecting an assignment of a task included in the distributed processing that is executed by the devices included in the first group, to the first device. For example, the sensing unit 1004 detects an assignment of the distributed processing to the main group, enabling detection of whether intermediate process results that are to be returned to the master terminal MT of the main group are retained, when registration is to be deleted from the main group.

The sensing unit 1004 has a function of detecting use of a memory area of the shared memory Mc that is shared by the devices included in the first group. Here, the memory area is the distributed shared memory area Md described above. For example, the sensing unit 1004 detects that data is retained in the distributed shared memory area Md that is provided for the shared memory Mc of the main group. Thus, whether data that is to be returned to the master terminal MT of the main group is retained can be detected, when registration is to be deleted from the main group.

The sensing unit 1004 has a function of detecting an assignment of a task that is included in the distributed processing that is executed by the devices included in the second group, to the first device. For example, the sensing unit 1004 detects an assignment of the distributed processing of the subgroup, enabling detection that the process under execution is a process of the subgroup.

The migrating unit 1005 has a function of migrating a task to a device among the devices of the first group. For example, the migrating unit 1005 migrates intermediate process results to another terminal MT of the main group, when assignment of the distributed processing of the main group has been detected by the sensing unit 1004, thereby enabling the distributed processing of the main group to be continued even when registration has been deleted from the main group.

The migrating unit 1005 has a function of migrating data in a memory area to a device among the devices of the first group. For example, the migrating unit 1005 migrates data that is in the distributed shared memory area Md to another terminal MT of the main group, if the sensing unit 1004 detects that the data is retained in the distributed shared memory area Md, thereby enabling the distributed processing of the main group to be continued even when registration has been deleted from the main group.

The migrating unit 1005 has a function of migrating a task to a device among the devices included in the second group. For example, when the execution of a process of the main group is started consequent to a process request received by the receiving unit 1003, the migrating unit 1005 migrates to another terminal MT of the subgroup, intermediate process results of the process of the subgroup under execution.

For example, the migrating unit 1005 migrates intermediate process results of the process of the subgroup under execution to another terminal MT of the subgroup, when a process that has to be executed in the terminal MT of the migrating unit 1005 is detected by the detecting unit 1001. Thus, when a process whose execution is to be given priority over the process of the subgroup arises at the terminal MT of the migrating unit 1005, intermediate process results are returned, thereby enabling the distributed processing of the subgroup to be continued.

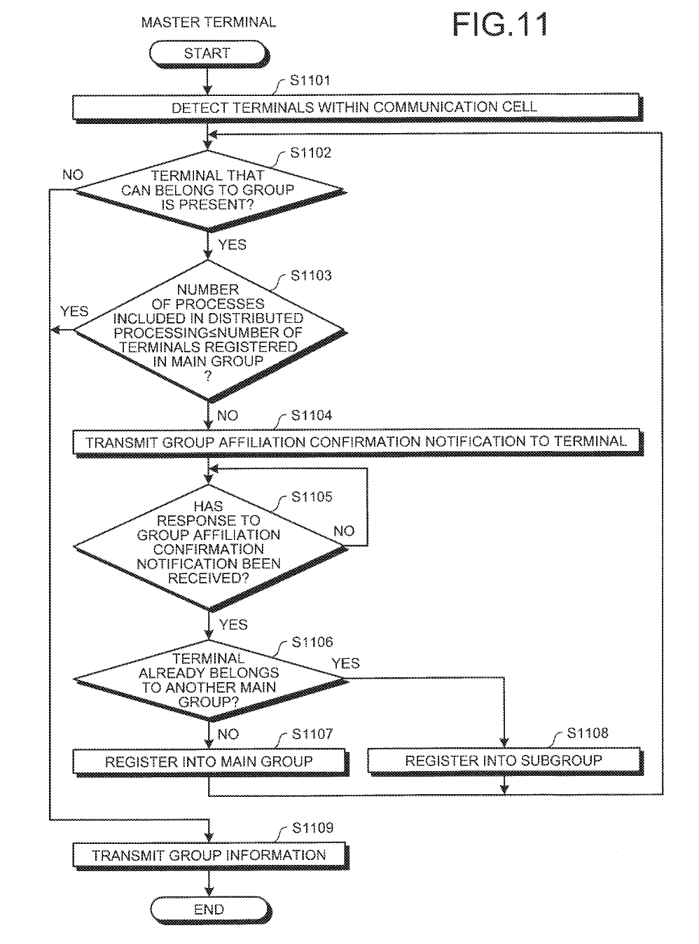

With reference to FIGS. 11 to 15, processes performed by the master terminal MT, the slave terminal MT, and the base station, when the groups to perform distributed processing are formed by the master terminal MT depicted in FIG. 1 will be described.

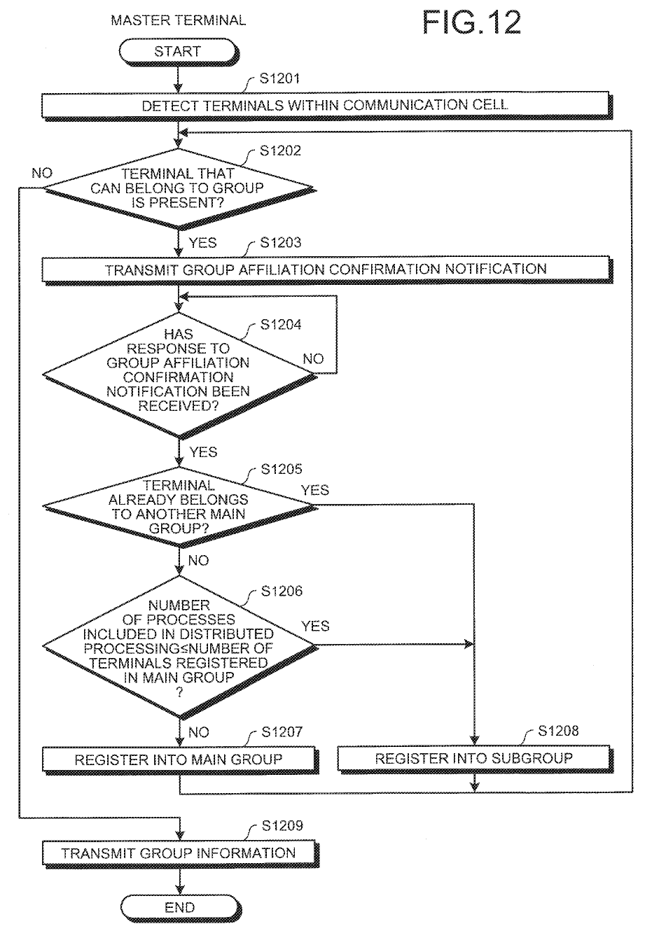

The registration process of slave terminals MT performed by the master terminal MT will be described. The master terminal MT adopts and executes as the registration process of slave terminals MT, any one among a registration process 1 depicted in FIG. 11 and a registration process 2 depicted in FIG. 12.

With reference to FIG. 11, the registration process 1 of slave terminals MT performed by the master terminal MT will be described. The registration process 1 represents a process example performed by the master terminal MT that completes a process, when a sufficient number of terminals MT have been registered in the main group to perform parallel processing of all the processes included in the distributed processing.

FIG. 11 is a flowchart of the registration process 1 of slave terminals MT performed by the master terminal MT. The CPU 301 detects terminals MT within the communication cell (step S1101). The CPU 301 determines whether a terminal MT that can belong to the group is among the detected terminals MT (step S1102).

If a terminal MT that can belong to the group is present (step S1102: YES), the CPU 301 determines if the number of processes included in the distributed processing is less than or equal to the number of terminals MT currently registered in the main group (step S1103).

If the number of processes included in the distributed processing is greater than the number of terminals MT currently registered in the main group (step S1103: NO), the CPU 301 transmits group affiliation confirmation notification to the terminal MT (step S1104), and determines whether a response to the group affiliation confirmation notification has been received (step S1105).

If no response has been received (step S1105: NO), the CPU 301 returns to step S1105 and awaits a response. On the other hand, if a response has been received (step S1105: YES), the CPU 301 determines whether the terminal MT already belongs to another main group (step S1106).

If the terminal MT does not yet belong to another main group (step S1106: NO), the CPU 301 registers the terminal MT into the main group (step S1107), and returns to step S1102.

On the other hand, if the terminal MT already belongs to another main group (step S1106: YES), the CPU 301 registers the terminal MT into the subgroup (step S1108), and returns to step S1102.

At step S1102, if no terminal MT that can belong the group is present (step S1102: NO), the CPU 301 transmits group information (step S1109), and ends the registration process.

At step S1103, if the number of processes included in the distributed processing is less than or equal to the number of terminals MT currently registered in the main group (step S1103: YES), the CPU 301 transmits the group information (step S1109), and ends the registration process.

Thus, the master terminal MT registers into the main group, terminals MT of a number that is sufficient for parallel processing of all the processes included in the distributed processing. Further, the master terminal MT registers terminals MT that belong to another group into the subgroup and not into the main group, thereby enabling a process of the distributed processing to not be assigned as far as possible to a terminal MT whose CPU 301 is used primarily for the distributed processing of another group.

Here, the master terminal MT may notify the terminals MT in the group of the creation of the shared memory Mc and create the shared memory Mc, which is an aggregation of the distributed shared memory areas Md provided by the terminals MT. If the shared memory Mc is created, the master terminal MT assigns addresses to the shared memory Mc.

With reference to FIG. 12, the registration process 2 of slave terminals MT performed by the master terminal MT will be described. The registration process 2 represents a process example of the master terminal MT, which continues the registration process as long as terminals MT that can be registered are present, even if sufficient terminals MT for parallel processing of all the processes included in the distributed processing have been registered in the main group.

FIG. 12 is a flowchart of the registration process 2 of slave terminals MT performed by the master terminal MT. The CPU 301 detects terminals MT within the communication cell (step S1201). The CPU 301 determines whether a terminal MT that can belong to the group is among the detected terminals MT (step S1202).

If a terminal MT that can belong to the group is present (step S1202: YES), the CPU 301 transmits group affiliation confirmation notification to the terminal MT (step S1203), and determines whether a response to the group affiliation confirmation notification has been received (step S1204).

If no response has been received (step S1204: NO), the CPU 301 returns to step S1204 and awaits a response. On the other hand, if a response has been received (step S1204: YES), the CPU 301 determines whether the terminal MT already belongs to another main group (step S1205).

If terminal MT already belongs to another main group (step S1205: YES), the CPU 301 registers the terminal MT into the subgroup (step S1208), and returns to step S1202.

On the other hand, if the terminal MT does not yet belong to another main group (step S1205: NO), the CPU 301 determines if the number of processes included in the distributed processing is less than or equal to the number of terminals MT currently registered in the main group (step S1206).

If the number of processes included in the distributed processing is greater than the number of terminals MT currently registered in the main group (step S1206: NO), the CPU 301 registers the terminal MT into the main group (step S1207), and returns to step S1202.

On the other hand, if the number of processes included in the distributed processing is less than or equal to the number of terminals MT currently registered in the main group (step S1206: YES), the CPU 301 registers the terminal MT into the subgroup (step S1208), and returns to step S1202.

At step S1202, if no terminal MT that can belong the group is present (step S1202: NO), the CPU 301 transmits the group information (step S1209), and ends the registration process.

Thus, the master terminal MT registers into the main group, terminals MT of a number that is sufficient for parallel processing of all the processes included in the distributed processing. Further, the master terminal MT continues to register terminals MT into the subgroup as long as terminals MT that can be registered into the group are present. Further, the master terminal MT registers terminals MT that belong to another group into the subgroup and not into the main group, thereby enabling a process of the distributed processing to not be assigned as far as possible to a terminal MT whose CPU 301 is used primarily for the distributed processing of another group.

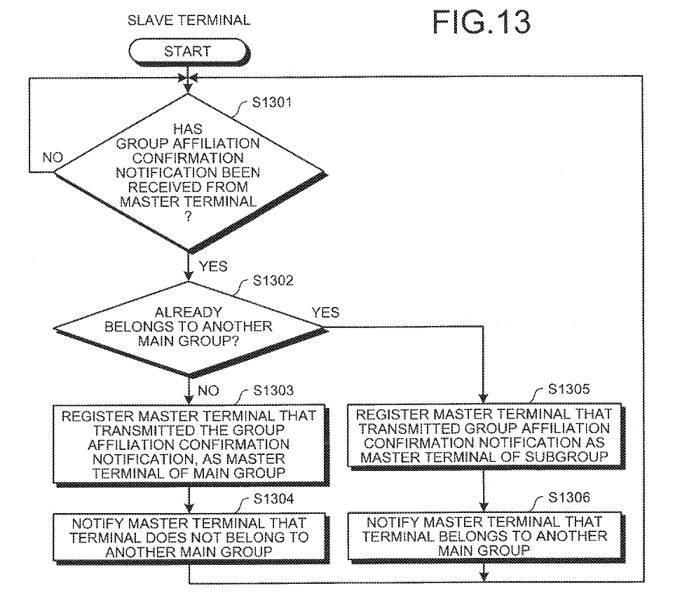

With reference to FIG. 13, a response process performed by the slave terminal MT that has received the group affiliation confirmation notification transmitted by the master terminal MT at step S1104 or step S1203 will be described.

FIG. 13 is a flowchart of the response process performed by the slave terminal MT that has received the group affiliation confirmation notification transmitted by the master terminal MT. The CPU 301 determines whether group affiliation confirmation notification has been received from the master terminal MT (step S1301).

If group affiliation confirmation notification has not been received (step S1301: NO), the CPU 301 returns to step S1301, and awaits group affiliation confirmation notification. On the other hand, if group affiliation confirmation notification has been received (step S1301: YES), the CPU 301 determines whether the terminal MT thereof already belongs to a main group (step S1302).

If the terminal MT does not already belong to another main group (step S1302: NO), the CPU 301 registers the master terminal MT that transmitted the group affiliation confirmation notification, as the master terminal MT of the main group (step S1303). The CPU 301 notifies the master terminal MT that transmitted the group affiliation confirmation notification, that the terminal MT does not belong to another main group (step S1304), and returns to step S1301.

On the other hand, if the terminal belongs to another main group (step S1302: YES), the CPU 301 registers the master terminal MT that transmitted the group affiliation confirmation notification as the master terminal MT of the subgroup (step S1305). The CPU 301 notifies the master terminal MT that transmitted the group affiliation confirmation notification that the terminal MT belongs to another main group (step S1306), and returns to step S1301.

Thus, slave terminal MT notifies the master terminal MT of the group affiliation state of the slave terminal MT.

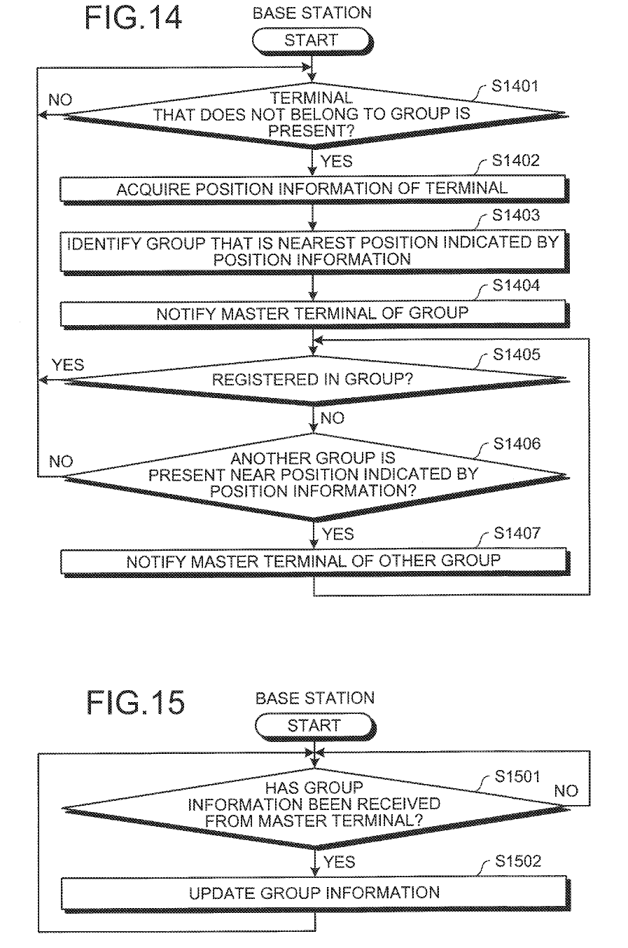

With reference to FIG. 14, a terminal MT position information transmission process performed by the base station BS will be described. The transmitted terminal MT position information is received by the master terminal MT at step S1101 or step S1201.

FIG. 14 is a flowchart of the terminal MT position information transmission process performed by the base station BS. The CPU 301 determines whether in the communication cell C of the base station BS, a terminal MT that does not belong to a group is present (step S1401). If no such terminal MT is present (step S1401: NO), the CPU 301 returns to step S1401, and continues to determine whether in the communication cell C of the base station BS, a terminal MT that does not belong to a group is present.

If a terminal MT that does not belong to a group is present (step S1401: YES), the CPU 301 acquires the position information of the terminal MT (step S1402). The CPU 301 identifies the group that is nearest the position indicated by the acquired position information (step S1403). The CPU 301 notifies the master terminal MT of the identified group that a terminal MT that does not belong to a group is present (step S1404).

The CPU 301 determines whether the non-affiliated terminal MT is registered in the identified group (step S1405). If the terminal MT is registered (step S1405: YES), the CPU 301 returns to step S1401 and continues to determine whether in the communication cell C of the base station BS, a terminal MT that does not belong to a group is present.

If the terminal MT is not registered (step S1405: NO), the CPU 301 determines whether another group is present near the position indicated by the acquired position information (step S1406). If no other group is present nearby (step S1406: NO), the CPU 301 returns to step S1401 and continues to determine whether in the communication cell C of the base station BS, a terminal MT that does not belong to a group is present.

On the other hand, if another group is present (step S1406: YES), the CPU 301 notifies the master terminal MT of the other group that a terminal MT that does not belong to a group is present (step S1407). The CPU 301 returns to step S1405 and determines whether the terminal MT is registered in the other group.

Thus, the master terminal MT of the nearest group is notified of the presence of the terminal MT that does not belong to a group, enabling the registration process to a group to be started. Consequently, the registration process to the nearest group can be started by the master terminal MT that has the fastest ad hoc communication speed with the terminal MT that does not belong to a group.

If the terminal MT is not registered in the first group, the master terminal MT of the other group is again notified, enabling the master terminal MT to start the registration process. Consequently, other than the nearest group, if there is a group that will use the terminal MT for distributed processing, the terminal MT can be registered.

With reference to FIG. 15, a group information registration process performed by the base station BS that receives the group information transmitted by the master terminal MT at step S1109 or step S1209 will be described.

FIG. 15 is a flowchart of the group information registration process performed by the base station BS. The CPU 301 determines whether group information has been received from the master terminal MT (step S1501).

If group information has not been received (step S1501: NO), the CPU 301 returns to step S1501 and awaits receipt of group information. On the other hand, if group information has been received (step S1501: YES), the CPU 301 updates the group information (step S1502), returns to step S1501, and awaits receipt of group information.

Thus, the group information is maintained in the latest state and whether a terminal MT in the communication cell C of the base station BS is a terminal MT that belongs to a group can be determined.

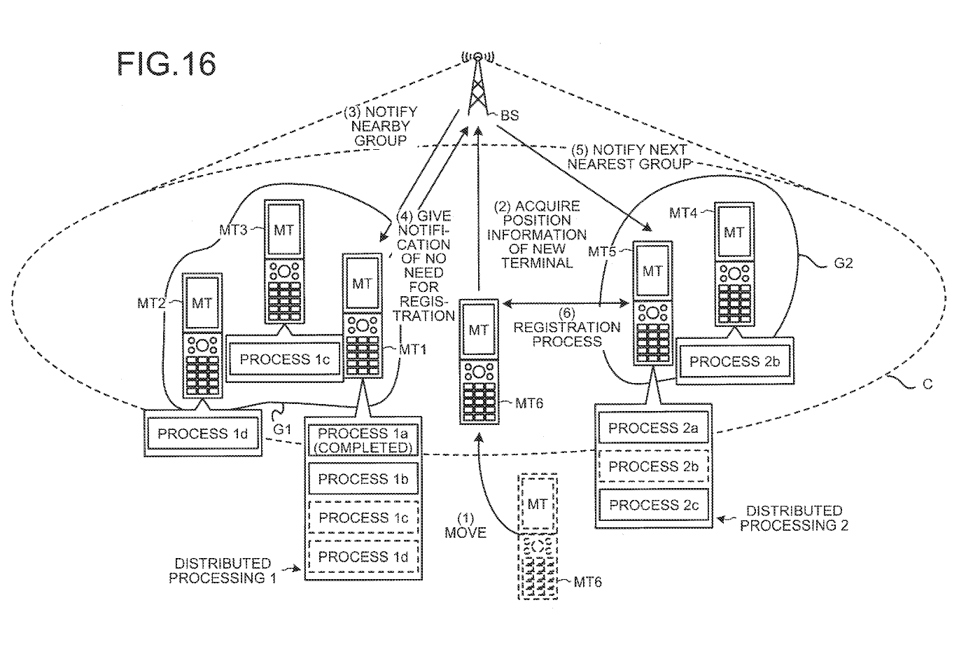

With reference to FIGS. 16 to 26, group reformation performed after the execution of the distributed processing has started will be described.

With reference to FIG. 16, group reformation in a case where a new terminal MT that does not belong to a group enters the communication cell C of the base station BS will be described.

FIG. 16 is a diagram depicting group reformation in a case where a new terminal MT enters the communication cell C of the base station BS. As depicted in FIG. 16, in the communication cell C of the base station BS, the terminal MT1 to MT5 are present. The terminal MT1 is a master terminal MT that controls the distributed processing 1, which includes the process 1a, the process 1b, a process 1c, and a process 1d. Further, the master terminal MT1 forms the group G1, which includes the master terminal MT1 and the slave terminals MT2 and MT3.

In the group G1, the master terminal MT1 assigns the process 1b to the master terminal MT1, the process 1c to terminal MT3, and the process 1d to terminal MT2; and causes each of the terminals MT1, MT3, and MT 2 to perform parallel processing. The process 1a has already been completed.

Meanwhile, the master terminal MT5 is a master terminal MT that controls distributed processing 2, which includes a process 2a, a process 2b, and a process 2c. Further, the master terminal MT5 forms the group G2, which includes the master terminal MT5 and the slave terminal MT4.

In the group G2, the master terminal MT5 assigns the process 2b to the terminal MT4 and the process 2a to the master terminal MT5; and causes each of the terminals MT4 and MT5 to perform parallel processing. The process 2c is not yet executed.

(1) Here, the terminal MT6 is assumed to move from outside the communication cell of the base station BS into the communication cell C.

(2) When the terminal MT6 enters the communication cell C of the base station BS, the base station BS acquires the position information of the terminal MT6. (3) The base station BS notifies the group G1, which is nearest the position indicated by the acquired position information, of the position information of the terminal MT6.

(4) The master terminal MT1 that has received the notification starts the registration process of registering the terminal MT6 into the group G1. Here, at the group G1, the process 1a has already been completed and the processes 1b to 1d are under execution at the terminals MT1 to MT3. In other words, the even if the terminal MT6 is registered into the group G1, there is no process to assign to the terminal MT. Therefore, the master terminal MT1 notifies the base station BS that registration is not necessary.

(5) The base station BS, upon receiving the notification from the master terminal MT 1, notifies the group G2, which is the second nearest group (after the group G1) to the position of the terminal MT6, of the position information of the terminal MT6.

(6) The master terminal MT5 that has received the notification starts the registration process of registering the terminal MT6 into the group G2. Here, at the group G2, the process 2c still remains unexecuted. Therefore, the master terminal MT5 registers the terminal MT6 into the group G2, reforms the group, assigns the process 2c to terminal MT6, and performs parallel processing of the distributed processing 2.

Thus, when a new terminal MT enters the communication cell C of the base station BS, the new terminal MT is registered into a group that has a process whose execution has not been started among the processes included in the distributed processing, enabling the group to be reformed. Consequently, in the reformed group, the process is assigned to the new terminal MT, enabling efficient distributed processing to be performed.

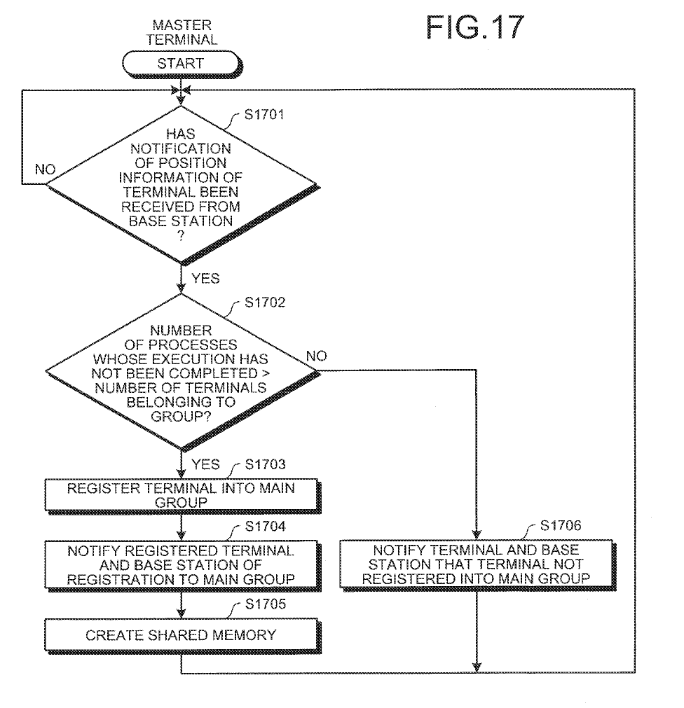

With reference to FIG. 17, a group reformation process performed by the master terminal MT depicted in FIG. 16 will be described.

FIG. 17 is a flowchart of the group reformation process performed by the master terminal MT. The CPU 301 determines whether notification of the position information of a new terminal MT has been received from the base station BS (step S1701). If notification has not been received (step S1701: NO), the CPU 301 returns to step S1701 and awaits notification from the base station BS.

On the other hand, if notification has been received (step S1701: YES), the CPU 301 determines whether the number of processes whose execution has not been completed in the distributed processing is greater than the number of terminals MT belonging to the group (step S1702).

If the number of processes is greater than the number of terminals MT belonging to the group (step S1702: YES), the CPU 301 registers the new terminal MT into the main group (step S1703). The CPU 301 notifies the registered terminal MT and the base station BS of the registration to main group (step S1704). The CPU 301 creates the shared memory Mc for the group that includes the newly registered terminal MT (step S1705), returns to step S1701, and awaits notification from the base station BS.

If the number of processes is less than or equal to the number of terminals MT belonging to the group (step S1702: NO), the CPU 301 notifies the terminal MT and the base station BS that the terminal MT will not be registered into the main group (step S1706). The CPU 301 returns to step S1701 and awaits notification from the base station BS.

Thus, when a new terminal MT enters the communication cell C of the base station BS, the new terminal MT is registered into a group that has a process whose execution has not been started among the processes included in the distributed processing, enabling the group to be reformed.

The transmission process and the registration process of the base station BS depicted in FIG. 16 and the response process of the slave terminal MT are the same as the processes depicted in FIGS. 13 to 15 and therefore, description thereof is omitted hereinafter.

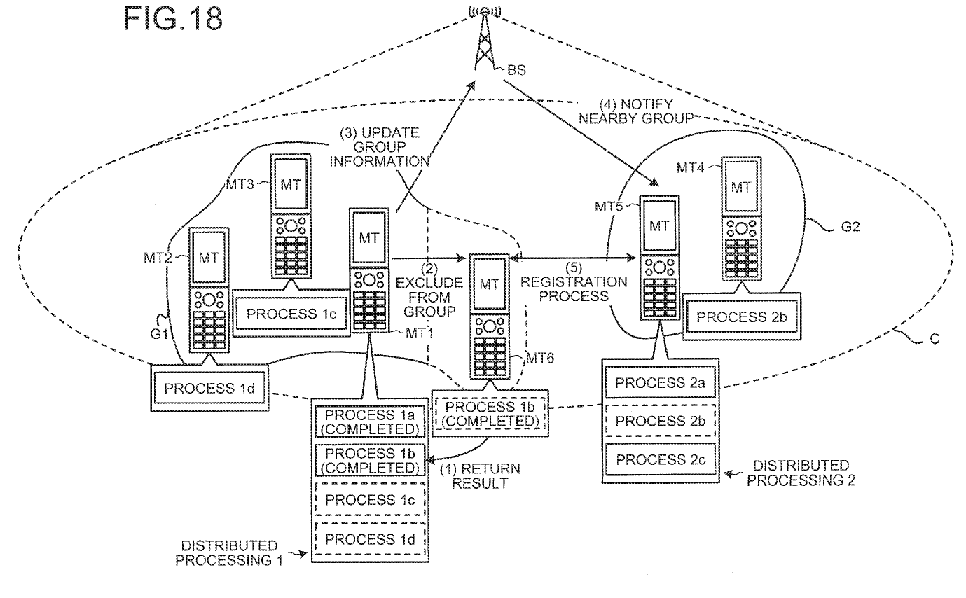

With reference to FIG. 18, group reformation in a case where a slave terminal MT in the group has completed execution of the assigned process.

FIG. 18 is a diagram depicting group reformation in a case where a slave terminal MT in the group has completed execution of the assigned process. As depicted in FIG. 18, in the communication cell C of the base station BS, the terminals MT1 to MT6 are present. The terminal MT1 is a master terminal MT that controls the distributed processing 1, which includes the process 1a, the process 1b, a process 1c, and a process 1d. Further, the master terminal MT1 forms the group G1, which includes the master terminal MT1 and slave terminals MT2, MT3, and MT6.

In the group G1, the master terminal MT1 assigns the process 1b to terminal MT6, the process 1c to terminal MT3, and the process 1d to terminal MT2; and causes each of the terminals MT1, MT2, MT3, and MT 6 to perform parallel processing. The process 1a has already been completed.

Meanwhile, the master terminal MT5 is a master terminal MT that controls distributed processing 2, which includes a process 2a, a process 2b, and a process 2c. Further, the master terminal MT5 forms the group G2, which includes the master terminal MT5 and the slave terminal MT4.

In the group G2, the master terminal MT5 assigns the process 2b to the terminal MT4 and the process 2a to the master terminal MT5; and causes each of the terminals MT4 and MT5 to perform parallel processing. The process 2c is not yet executed.

(1) Here, the terminal MT6 in the group G1 is assumed to have completed the execution of the process 1b. The terminal MT6, upon completing the execution of the process 1b, returns the process results of the process 1b to the master terminal MT1.

(2) The master terminal MT1 that has received the process results of the process 1b determines whether a process remains that can be assigned to the terminal MT6. At the group G1, a process whose execution has not been started does not remain and therefore, no process to assign to the terminal MT6 is present. Consequently, the master terminal MT1 excludes the terminal MT6 from the group G1.

(3) The master terminal MT1 transmits to the base station BS, the group information of the group G1 from which the registration of the terminal MT 6 has been deleted. As a result, the base station BS updates the group information stored by the base station BS.

(4) The base station BS that has updated the group information the group G1 notifies the master terminal MT of a group (other than the group G1) near the terminal MT6 that has been excluded from the group G1, of the position information of the terminal MT6. In this example, the base station BS notifies the master terminal MT5 of the group G2 of the position information of the terminal MT6.

(5) The master terminal MT5 that has received the notification starts the registration process of registering the terminal MT6 to the group G2. Here, at the group G2, the process 2c still remains unexecuted. Therefore, the master terminal MT5 registers the terminal MT6 into the group G2, reforms the group, assigns the process 2c to terminal MT6, and performs parallel processing of the distributed processing 2.

Thus, the master terminal MT excludes from the group, the terminal MT that has completed the process. As a result, the excluded terminal MT is registered into another group that has a process whose execution has not been started among the processes included in the distributed processing, enabling the group to be reformed. Consequently, in the reformed group, the process is assigned to the new terminal MT, enabling efficient distributed processing to be performed.

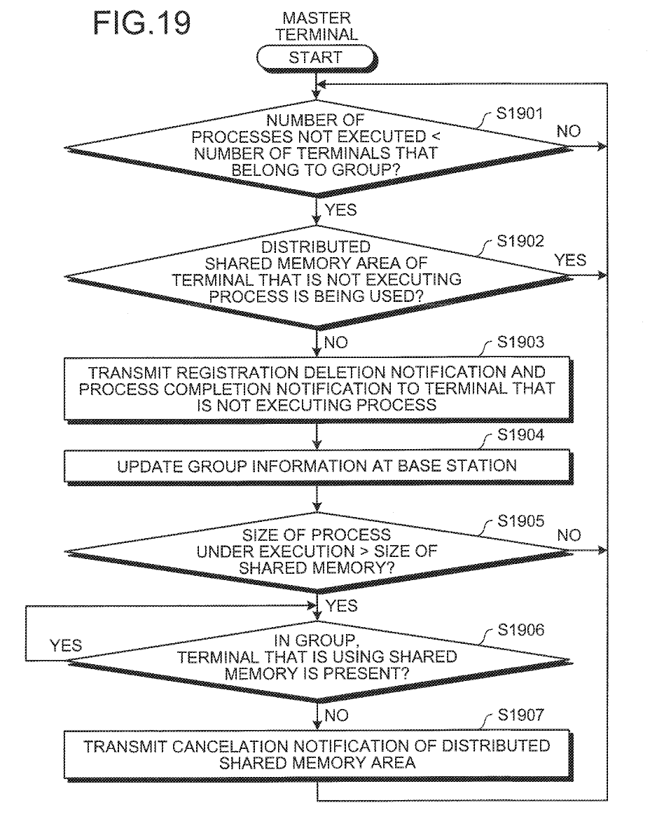

With reference to FIG. 19, group registration deletion process performed by the master terminal MT depicted in FIG. 18 will be described.

FIG. 19 is a flowchart of the group registration deletion process performed by the master terminal MT. The CPU 301 determines whether the number of processes that have not been executed is less the number of terminals MT that belong to the group (step S1901). If the number of processes that have not been executed is greater than or equal to the number of terminals MT that belong to the group (step S1901: NO), the CPU 301 returns to step S1901.

On the other hand, if the number of processes that have not been executed is less than the number of terminals MT that belong to the group (step S1901: YES), the CPU 301 determines whether the distributed shared memory area Md of the terminal MT that is not executing a process is being used (step S1902). If the distributed shared memory area Md is being used (step S1902: YES), the CPU 301 returns to step S1901.

On the other hand, if the distributed shared memory area Md is not being used (step S1902: NO), the CPU 301 transmits registration deletion notification and process completion notification to the terminal MT that is not executing a process (step S1903). The CPU 301 transmits the group information to the base station BS (step S1904).

The CPU 301 determines whether among the processes included in the distributed processing, the size of process under execution is greater than the size of the shared memory Mc (step S1905). If the size of the process under execution is less than or equal to the size of the shared memory Mc (step S1905: NO), the CPU 301 returns to step S1901.

On the other hand, if among the processes included in the distributed processing, the size of the process under execution is greater than the size of the shared memory Mc (step S1905: YES), the CPU 301 determines whether in the group, a terminal MT that is using the shared memory Mc is present (step S1906).

If a terminal MT that is using the shared memory Mc is present (step S1906: YES), the CPU 301 returns to step S1906. On the other hand, if no terminal MT that is using the shared memory Mc is present (step S1906: NO), the CPU 301 transmits cancelation notification of the distributed shared memory area Md (step S1907), and returns to step S1901. Thus, the registration of a terminal MT that has not been assigned a process can be deleted.

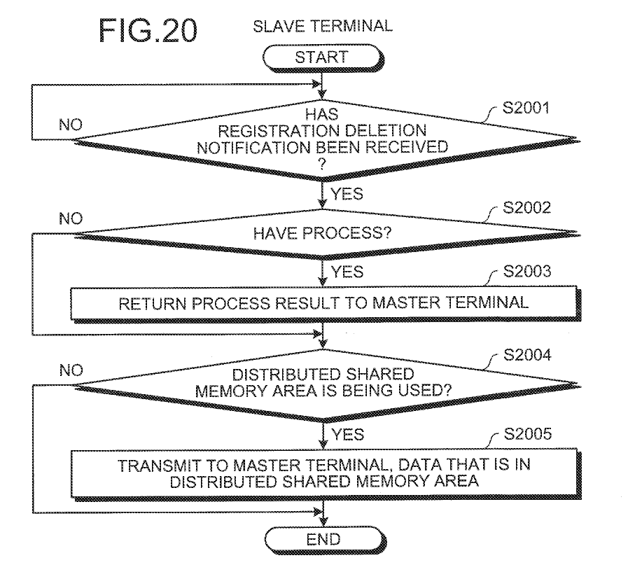

With reference to FIG. 20, a response process by the slave terminal MT that receives the registration deletion notification transmitted by the master terminal MT at step S1903 will be described.

FIG. 20 is a flowchart of a response process by the slave terminal MT that receives registration deletion notification transmitted by the master terminal MT. The CPU 301 determines whether registration deletion notification has been received (step S2001). If registration deletion notification has not been received (step S2001: NO), the CPU 301 returns to step S2001 and awaits registration deletion notification.

On the other hand, if registration deletion notification has been received (step S2001: YES), the CPU 301 determines whether the slave terminal MT has a process included in the distributed processing (step S2002). If the slave terminal MT has no process (step S2002: NO), the CPU 301 proceeds to step S2004.

On the other hand, if the slave terminal MT has a process (step S2002: YES), the CPU 301 returns to the master terminal MT, the process result of the process (step S2003), and proceeds to step S2004.

The CPU 301 determines whether the distributed shared memory area Md is being used (step S2004). If the distributed shared memory area Md is not being used (step S2004: NO), the CPU 301 ends the response process.

On the other hand, if the distributed shared memory area Md is being used (step S2004: YES), the CPU 301 transmits to the master terminal MT, data that is in the distributed shared memory area Md (step S2005), and ends the response process.

Thus, a slave terminal MT whose registration has been deleted from the group can return to the master terminal MT, the process result of the process of the slave terminal MT and data in the distributed shared memory area Md, thereby enabling the distributed processing to continue even the registration of the slave terminal MT is deleted from the group executing the distributed processing.

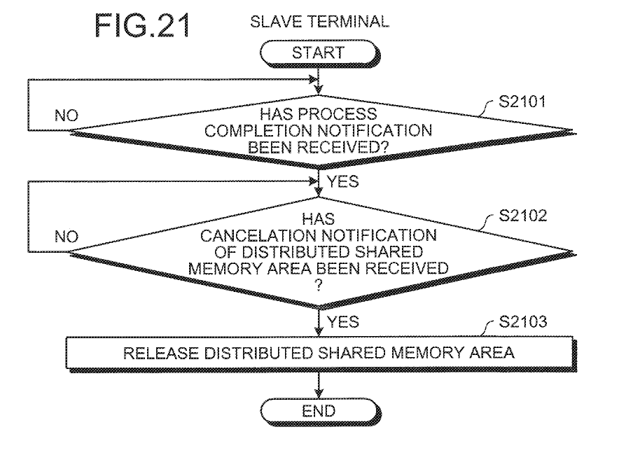

With reference to FIG. 21, a response process performed by the slave terminal MT that receives process completion notification from the master terminal MT step S1903 will be described.

FIG. 21 is a flowchart of a response process performed by the slave terminal MT that receives process completion notification from the master terminal MT. The CPU 301 determines whether process completion notification has been received (step S2101). If process completion notification has not been received (step S2101: NO), the CPU 301 returns to step S2101 and awaits process completion notification.

On the other hand, if process completion notification has been received (step S2101: YES), the CPU 301 determines whether cancelation notification of the distributed shared memory area Md has been received (step S2102). If cancelation notification has not been received (step S2102: NO), the CPU 301 returns to step S2102 and awaits cancelation notification.

On the other hand, if cancelation notification has been received (step S2102: YES), the CPU 301 releases the distributed shared memory area Md (step S2103), and ends the response process. Thus, a terminal MT whose registration has been deleted from the group releases the distributed shared memory area Md, enabling the released memory area to be used by a process arising at the slave terminal MT.

The reformation process of the master terminal MT depicted in FIG. 18 and the transmission process and the registration process of the base station BS are the same processes as those depicted in FIGS. 14, 15, and 17 and therefore, description thereof is omitted hereinafter.

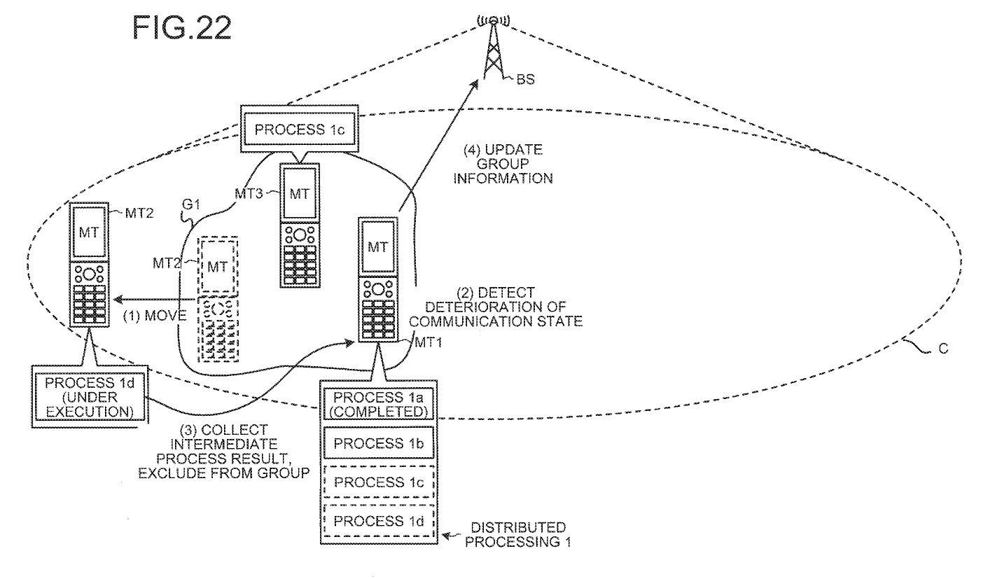

With reference to FIG. 22, group reformation in a case where the communication state between the master terminal MT and a terminal MT in the group thereof becomes poor will be described.

FIG. 22 is a diagram depicting group reformation in a case where the communication state between the master terminal MT and a terminal MT in the group thereof becomes poor. As depicted in FIG. 22, in the communication cell C of the base station BS, the terminals MT1 to MT3 are present. The terminal MT1 is a master terminal MT that controls the distributed processing 1, which includes the process 1a, the process 1b, a process 1c, and a process 1d. Further, the master terminal MT1 forms the group G1, which includes the master terminal MT1 and the slave terminals MT2 and MT3.

In the group G1, the master terminal MT1 assigns the process 1b to the master terminal MT1, the process 1c to terminal MT3, and the process 1d to terminal MT2; and causes each of the terminals MT1, MT3, and MT 2 to perform parallel processing. The process 1a has already been completed.

(1) Here, the communication state is assumed to become poor consequent to the distance between the terminal MT2 and the master terminal MT1 increasing as a result of the movement of the terminal MT2.

(2) The master terminal MT1 monitors the communication state and thereby, detects deterioration of the communication state with the terminal MT. For example, the master terminal MT1 monitors the communication strength and thereby, detects deterioration of the communication state.

(3) Upon detecting the deterioration of the communication state, the master terminal MT1 collects intermediate process results from the terminal MT2 and excludes the terminal MT2 from the group G1.

(4) The master terminal MT1 transmits to the base station BS, the group information of the group G1 from which the registration of the terminal MT2 has been deleted. As a result, the base station BS updates the group information stored by the base station BS.

Thus, intermediate process results are collected before the intermediate process results become impossible to collect consequent to deterioration of the communication state. Further, the terminal MT from which intermediate process results may become impossible to collect is excluded from the group, enabling stable distributed processing to be performed. Even if the communication state deteriorates consequent to movement of the master terminal MT1, the group is reformed in the same manner.

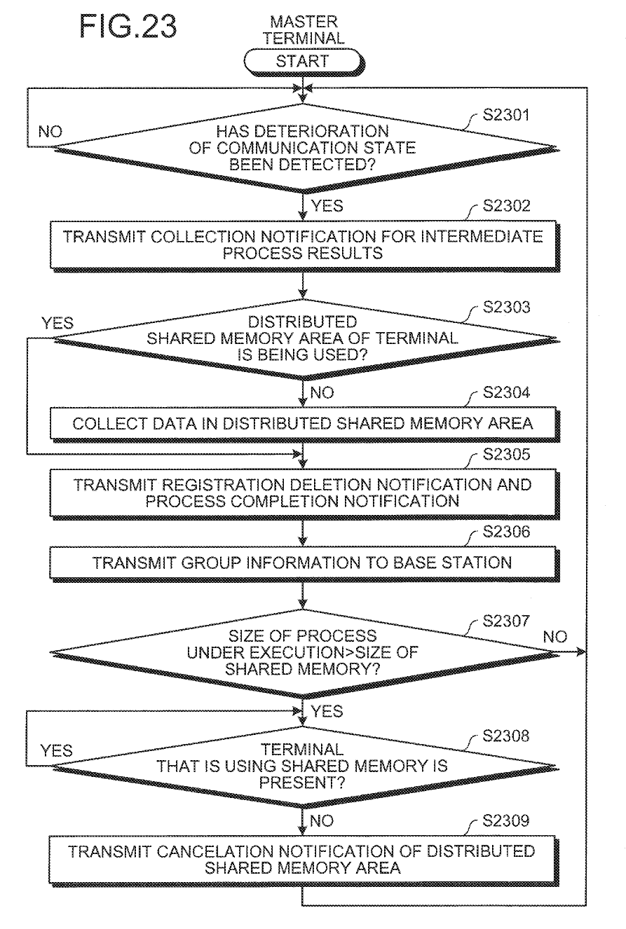

With reference to FIG. 23, group registration deletion process performed by the master terminal MT depicted in FIG. 22 will be described.

FIG. 23 is a flowchart of the group registration deletion process performed by the master terminal MT. The CPU 301 monitors the communication state and determines whether the communication state has deteriorated (step S2301). If the communication state has not deteriorated (step S2301: NO), the CPU 301 returns to step S2301 and continues to monitor the communication state.

On the other hand, if the communication state has deteriorated (step S2301: YES), the CPU 301 transmits collection notification for intermediate process results (step S2302). The CPU 301 determines whether the distributed shared memory area Md of the terminal MT is being used (step S2303). If the distributed shared memory area Md is being used (step S2303: YES), the CPU 301 proceeds to step S2305.

On the other hand, if the distributed shared memory area Md is not being used (step S2303: NO), the CPU 301 collects the data in the distributed shared memory area Md (step S2304), and proceeds to step S2305.

The CPU 301 deletes the registration from the group, and transmits registration deletion notification and process completion notification (step S2305). The CPU 301 transmits the group information to the base station BS (step S2306).

The CPU 301 determines whether the size of a process under execution among the processes included in the distributed processing is greater than the size of the shared memory Mc (step S2307). If the size of the process under execution is less than or equal to the size of the shared memory Mc (step S2307: NO), the CPU 301 returns to step S2301.

On the other hand, if the size of the process under execution is greater than the size of the shared memory Mc (step S2307: YES), the CPU 301 determines whether a terminal MT that is using the shared memory Mc is present (step S2308).

If a terminal MT that is using the shared memory Mc is present (step S2308: YES), the CPU 301 returns to step S2308. On the other hand, if no terminal MT that is using the shared memory Mc is present (step S2308: NO), the CPU 301 transmits cancelation notification of the distributed shared memory area Md (step S2309), and returns to step S2301.

Thus, the registration of a terminal with which the communication state has deteriorated can be deleted. Furthermore, intermediate process results and data in the distributed shared memory area Md can be collected from a terminal MT with which the communication state has deteriorated.

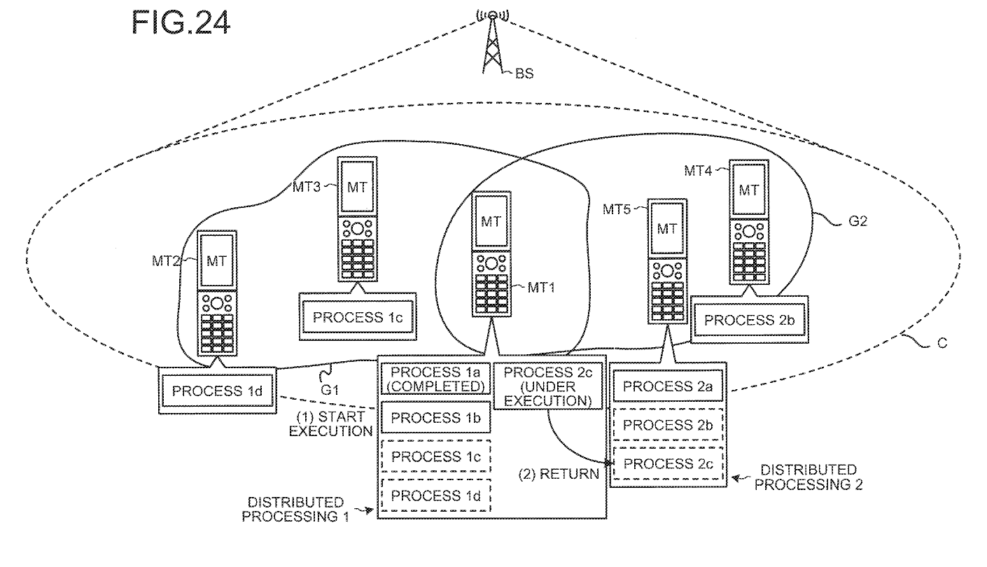

With reference to FIG. 24, distributed processing of the main group by a terminal MT that is executing the distributed processing of the subgroup will be described.

FIG. 24 is a diagram depicting the start of execution of distributed processing of the main group by a terminal MT that is executing distributed processing of the subgroup. As depicted in FIG. 24, in the communication cell C of the base station BS, the terminals MT1 to MT5 are present. The terminal MT1 is a master terminal MT that controls the distributed processing 1, which includes the process 1a, the process 1b, a process 1c, and a process 1d. Further, the master terminal MT1 forms the group G1, which includes the master terminal MT1 and the slave terminals MT2 and MT3.

In the group G1, the master terminal MT1 assigns the process 1c to the terminal MT3, the process 1d to the terminal MT2; and causes each of the terminals MT3 and MT2 to perform parallel processing. The process 1a has already been completed and the process 1b has not been executed.

On the other hand, the master terminal MT5 is a master terminal MT that controls distributed processing 2, which includes a process 2a, a process 2b, and a process 2c. Further, the master terminal MT5 forms the group G2, which includes the master terminal MT5, the slave terminal MT4, and the terminal MT1 that is also a slave terminal MT of the master terminal MT5.

In the group G2, the master terminal MT5 assigns the process 2a to the master terminal MT5, the process 2b to terminal MT4, and the process 2c to terminal MT1; and causes each of the terminals TM5, TM4, and TM1 to perform parallel processing.

Thus, taking this case where terminal MT1 is in the main group of the group G1 of the terminal MT1 and is in the subgroup of the group G2 of the terminal MT5 as an example, the start of execution of the distributed processing of the main group by the terminal MT1 will be described.

(1) Here, the terminal MT1 is assumed to attempt to start the execution of the process 1b of the main group during the execution of the process 2c.

(2) Before the start of the execution of the process 1b, the terminal MT1 returns intermediate process results of the process 2c to the master terminal MT5 in order to start the execution of the process 1b.

Thus, terminal MT1 can give priority to and execute processes of the main group. Further, before the start of a process of the main group, the terminal MT 1 returns the intermediate process results to the master terminal MT5 of the subgroup, enabling the distributed processing of the master terminal MT5 to continue without interruption.

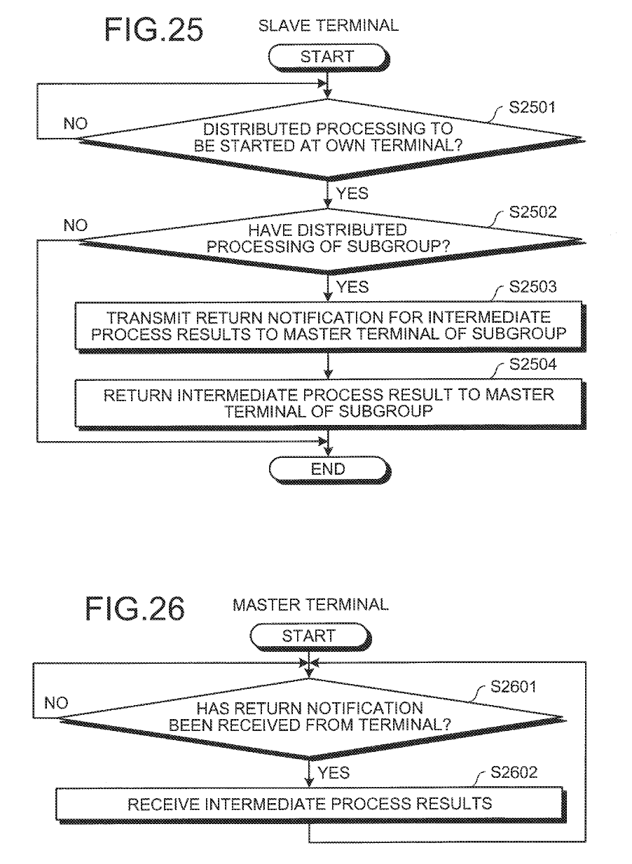

With reference to FIG. 25, distributed processing of the main group by a terminal MT that belongs to the main group of one group and the subgroup of another as depicted in FIG. 24 will be described.

FIG. 25 is a flowchart of a start process of execution of distributed processing of the main group. The CPU 301 determines whether distributed processing of the main group is to be started at the terminal MT thereof (step S2501). If the distributed processing is not to be started (step S2501: NO), the CPU 301 returns to step S2501 and awaits the start of the distributed processing.

On the other hand, if the distributed processing is to be started (step S2501: YES), the CPU 301 determines whether the terminal MT thereof has distributed processing of the subgroup (step S2502). If the terminal MT thereof does not have distributed processing of the subgroup (step S2502: NO), the CPU 301 ends the start process of execution of the distributed processing of the main group.

On the other hand, if the terminal MT thereof has distributed processing of the subgroup (step S2502: YES), the CPU 301 transmits return notification for intermediate process results to the master terminal MT of the subgroup (step S2503), and returns the intermediate process results (step S2504). The CPU 301 ends the start process of execution of the distributed processing of the main group.

Thus, distributed processing of the main group can be given priority over the execution of the distributed processing of the subgroup, enabling the start of execution thereof. Further, when the execution of the distributed processing of the main group is to be started, intermediate process results of the distributed processing of the subgroup and data in the distributed shared memory area Md are returned, enabling the distributed processing of the subgroup to be continued.

With reference to FIG. 26, a data collection process performed by the master terminal MT that is of the subgroup and that receives the return notification transmitted by the terminal MT at step S2503 will be described. However, the operation at step S2602 is the same as the operation at step S2302 depicted in FIG. 23 and therefore, description thereof will be omitted hereinafter.

FIG. 26 is a flowchart of a data collection process performed by the master terminal MT of the subgroup. The CPU 301 determines whether return notification has been received from a terminal MT (step S2601). If return notification has not been received (step S2601: NO), the CPU 301 returns to step S2601 and awaits return notification.

On the other hand, if return notification has been received (step S2601: YES), the CPU 301 proceeds to step S2602. The CPU 301 performs the operation at step S2602.

Thus, intermediate process results of the distributed processing are collected from terminal MT, enabling the distributed processing to be continued.

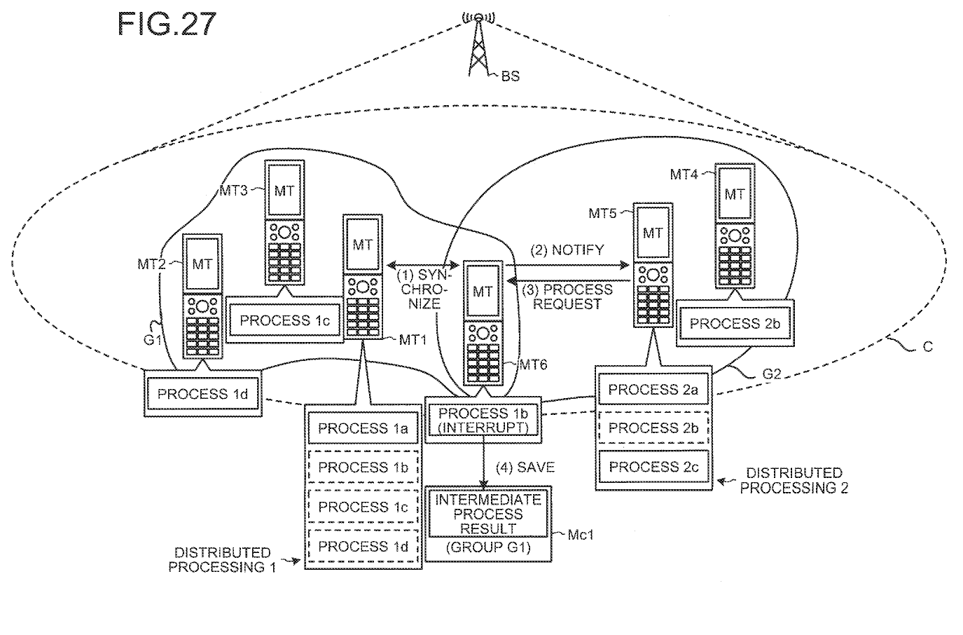

With reference to FIG. 27, a process request by the master terminal MT to the slave terminal MT of the subgroup, will be described for a case when only at the slave terminal MT of the main group, parallel processing cannot be simultaneously performed for all of the processes included in the distributed processing.

FIG. 27 is a diagram depicting a process request by the master terminal MT to a slave terminal MT of the subgroup. As depicted in FIG. 27, in the communication cell C of the base station BS, the terminals MT1 to MT6 are present. The terminal MT1 is a master terminal MT that controls the distributed processing 1, which includes the process 1a, the process 1b, a process 1c, and a process 1d. Further, the master terminal MT1 forms the group G1, which includes the master terminal MT1 and slave terminals MT2, MT3, and MT6.

In the group G1, the master terminal MT1 assigns the process 1a to the master terminal MT1, the process 1b to terminal MT6, the process 1c to terminal MT3, and the process 1d to terminal MT2; and causes each of the terminals MT1, MT2, MT3, and MT6 to perform parallel processing. The process 1a and the process 1b are processes that are subject to synchronization control and during the execution of one of the processes, the execution of the other is interrupted.

Meanwhile, the master terminal MT5 is a master terminal MT that controls distributed processing 2, which includes a process 2a, a process 2b, and a process 2c. Further, the master terminal MT5 forms the group G2, which includes the master terminal MT5, and the slave terminals MT4 and MT6. In the group G2, the slave terminal MT4 belongs to the main group. Further, in the group G2, the slave terminal MT6 belongs to the subgroup.

In the group G2, the master terminal MT5 assigns the process 2a to the master terminal MT5, the process 2b to terminal MT4; and causes each of the terminals MT5 and MT4 to perform parallel processing. The process 2c has not been executed.

(1) Here, the slave terminal MT6 is assumed to interrupt the execution of the process 1b since the process 1a is under execution by the master terminal MT1. Upon the interruption of the execution of the process 1b, the CPU 301 of the slave terminal MT6 enters an idle state, enabling the execution of the distributed processing of the subgroup.

(2) Consequently, upon the interruption of the execution of the process 1b, the slave terminal MT6 refers to the master terminal information DB 600 and transmits to the master terminal MT5 of the subgroup, availability notification indicating that the terminal MT6 can accept a process request.

(3) The master terminal MT5 that has received the availability notification selects the process 2c, which has not yet been executed among the processed included in the distributed processing, and transmits a process request to the slave terminal MT6.

(4) Upon receiving the process request, the slave terminal MT6 saves the intermediate process results of the process 1b to the shared memory Mc1 of the group G1 and executes the process 2c. If the size of the memory M of the slave terminal MT6 is of a size that can retain the intermediate process results of the process 1b and the process results of the process 2c, the intermediate process results need not be saved to the shared memory Mc1.

Thus, a slave terminal MT of the subgroup and whose CPU 301 has entered an idle state is used for parallel processing of the distributed processing, thereby enabling the efficiency of the distributed processing to be improved. Further, the utilization rate of the CPU 301 of the slave terminal MT is increased, which enables the processing efficiency of the entire network system 200 to be improved.

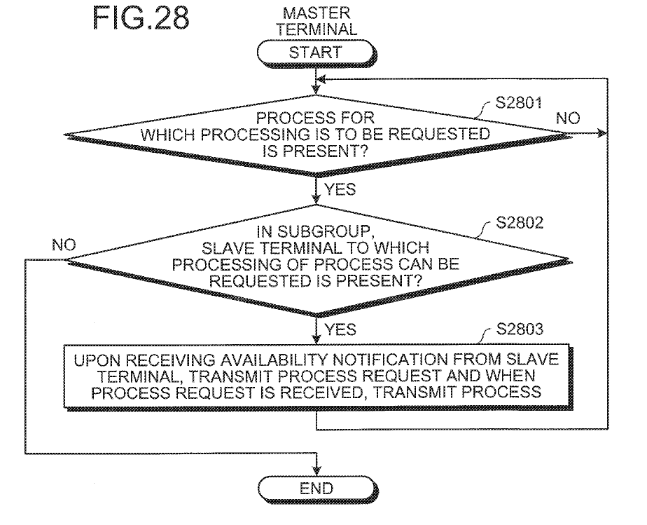

With reference to FIG. 28, a processing-request process performed by the master terminal MT depicted in FIG. 27 to request a slave terminal MT of the subgroup to perform distributed processing will be described.

FIG. 28 is a flowchart of the processing-request process performed by the master terminal MT to request a slave terminal MT of the subgroup to perform distributed processing. The CPU 301 determines whether a process for which processing is to be requested is present (step S2801). If no such process is present (step S2801: NO), the CPU 301 returns to step S2801 and continues to determine whether a process for which processing is to be requested is present.

On the other hand, if such a process is present (step S2801: YES), the CPU 301 determines whether among the slave terminals MT belonging to the subgroup, a slave terminal MT to which the processing of the process can be requested is present (step S2802). If no such slave terminal MT is present (step S2802: NO), the CPU 301 ends processing-request process.

On the other hand, if such a slave terminal MT is present (step S2802: YES), the CPU 301, upon receiving availability notification from the slave terminal MT, transmits a process request and when the process request is received, transmits the process (step S2803), and returns to step S2801.

Thus, when a process that can be assigned is present among the processes included in the distributed processing and a slave terminal MT to which the processing of the process can be requested is present, the process can be assigned and executed, thereby enabling the efficiency of the distributed processing to be improved.

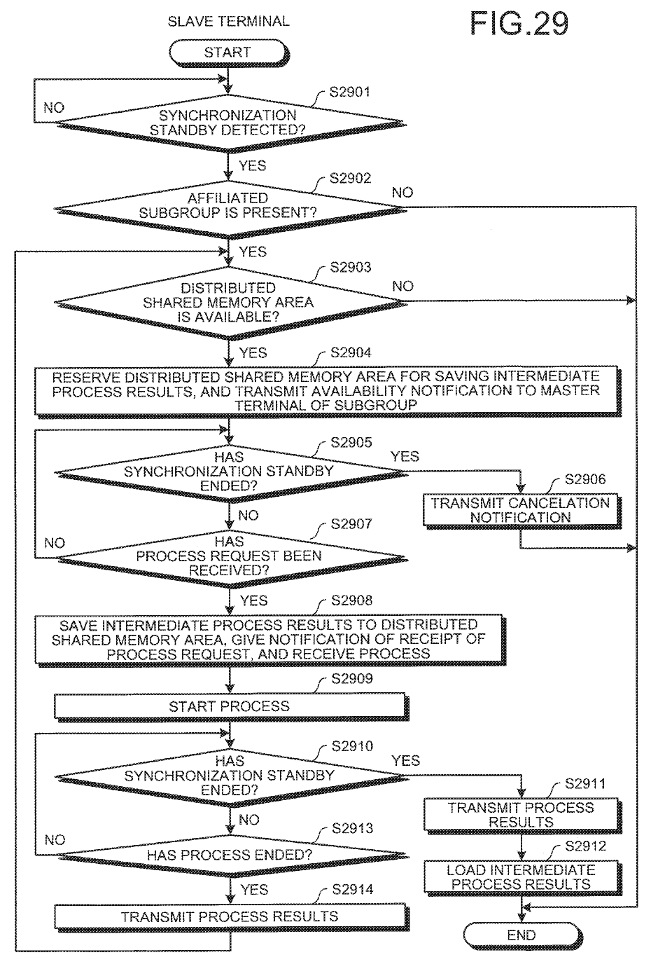

With reference to FIG. 29, a processing-request accepting process that is performed by a slave terminal MT that receives the process request transmitted by the master terminal MT at step S2803 will be described.

FIG. 29 is a flowchart of the processing-request accepting process performed by a slave terminal MT. The CPU 301 determines whether synchronization standby related to exclusive control from the master terminal MT of the main group has been detected (step S2901). If synchronization standby has not been detected (step S2901: NO), the CPU 301 returns to step S2901 awaits detection of synchronization standby.

On the other hand, if synchronization standby has been detected (step S2901: YES), the CPU 301 puts the process that is under execution on standby for synchronization and interrupts execution. The CPU 301 determines whether an affiliated subgroup is present (step S2902). If no affiliated subgroup is present (step S2902: NO), the CPU 301 ends the processing-request accepting process.

On the other hand, if an affiliated subgroup is present (step S2902: YES), the CPU 301 determines whether the distributed shared memory area Md is available (step S2903). If the distributed shared memory area Md is not available (step S2903: NO), the CPU 301 ends the processing-request accepting process.

On the other hand, if the distributed shared memory area Md is available (step S2903: YES), the CPU 301 reserves the distributed shared memory area Md for saving intermediate process results, and transmits availability notification to the master terminal MT of the subgroup (step S2904).

The CPU 301 determines whether the synchronization standby has ended (step S2905). The ending of the synchronization standby occurs, for example, consequent to the receipt of release notification for the synchronization standby from the master terminal MT of the main group. If the synchronization standby has ended (step S2905: YES), the CPU 301 transmits cancelation notification of the availability notification to the master terminal MT of the subgroup (step S2906), and ends the processing-request accepting process.

On the other hand, if the synchronization standby has not ended (step S2905: NO), the CPU 301 determines whether a process request has been received from the master terminal MT of the subgroup (step S2907). If a process request has not been received (step S2907: NO), the CPU 301 returns to step S2905.

On the other hand, is a process request has been received (step S2907: YES), the CPU 301 saves intermediate process results to the distributed shared memory area Md, gives notification of availability to accept a process request, and receives a process (step S2908). Based on the process request from the subgroup, the CPU 301 starts the process (step S2909).

The CPU 301 determines whether the synchronization standby has ended (step S2910). The ending of the synchronization standby occurs, for example, consequent to a receipt of release notification from the master terminal MT of the main group.

If the synchronization standby has ended (step S2910: YES), the CPU 301 transmits to the master terminal MT of the affiliated group, the process results of the process started at step S2909 (step S2911). The CPU 301 loads the intermediate process results saved in the distributed shared memory area Md (step S2912), and ends the processing-request accepting process.

On the other hand, if the synchronization standby has not ended (step S2910: NO), the CPU 301 determines whether the process started at step S2909 has ended (step S2913). If the process has not ended (step S2913: NO), the CPU 301 returns to step S2910.

On the other hand, if the process has ended (step S2913: YES), the CPU 301 transmits to the master terminal MT of the subgroup, the process results of the process started at step S2909 (step S2914), and returns to step S2903.

However, accompanying the completion of the process started at step S2909, the CPU 301 may load the intermediate process results saved in the distributed shared memory area Md. Further, the CPU 301 may wait for the synchronization standby to end and resume the interrupted process.

Thus, slave terminal MT saves intermediate process results to the distributed shared memory area Md, enabling a work area to be reserved in the RAM 303 used by a process that is requested by the master terminal MT of the subgroup. Further, the terminal MT loads into the work area of the RAM 303, the intermediate process results saved in the distributed shared memory area Md, enabling the process to be resumed.

As described, according to the data processing method, a slave terminal MT that does not belong to another group is registered into the main group. Further, a slave terminal that belongs to another group is registered into the subgroup, not into the main group.

Thus, slave terminals MT that can primarily execute processes according to process requests from the master terminal MT are selected and registered into the main group, thereby enabling the group to be formed of terminals that can efficiently perform parallel processing of the distributed processing. As far as possible, process requests are not made to a subgroup slave terminal MT, which is not included in the main group, thereby enabling increase of load on the slave terminal to be prevented.

As the subgroup, slave terminals MT that perform process requests ad interim are registered, thereby enabling processes to be assigned thereto ad interim, according to changes in the state of the slave terminals MT of the main group, occurring consequent to the terminals MT being mobile and thus, enabling parallel processing to be performed. A slave terminal registered in the subgroup whose CPU has entered an idle state after completing the distributed processing of another group or whose execution of the distributed processing for another group has been interrupted can be requested to perform a process ad interim, enabling the efficiency of the distributed processing to be improved.

According to the data processing method, the comparison result of the number of terminals MT currently registered in the main group and the number of processes included in the distributed processing is referred to and the registration process of a slave terminal MT to the main group or the subgroup is started.

For example, according to data processing method, if the number of terminals MT currently registered in the main group is greater than or equal to the number of processes included in the distributed processing, registration of the slave terminal MT is not performed, thereby establishing some leeway to enable another group to register the slave terminal MT into the main group thereof.

Further, according to the data processing method, if the number of terminals MT currently registered in the main group is less the number of processes included in the distributed processing, a slave terminal MT is registered into the main group, whereby slave terminals MT are registered into the main group until the number of terminals MT registered in the main group become equivalent to the number of processes, thereby enabling the efficiency of the parallel processing of the distributed processing to be improved.

According to the data processing method, if the number of terminals MT currently registered in the main group is greater than or equal to the number of processes included in the distributed processing, a slave terminal MT is registered into the subgroup, whereby slave terminals MT are registered into the subgroup and not into the main group, thereby enabling another group to register the slave terminals MT into the main group thereof.

According to the data processing method, synchronization requests to the slave terminals registered in the subgroup are registered, thereby enabling registration of whether the slave terminals MT are able to accept processing requests.

According to the data processing method, the base station BS is notified of the registration of a slave terminal MT to the main group or non-registration of the slave terminal MT, enabling the base station BS to update the group information DB 800 of the base station BS. Thus, the base station BS is able to grasp group affiliations of slave terminals MT in the communication cell C.

According to the data processing method, if the number of terminals MT currently registered in the main group is greater than or equal to the number of processes included in the distributed processing, the registration of a slave terminal MT registered in the group is deleted. Thus, when the number of terminals MT currently registered in the main group exceeds a number sufficient for assigning the processes of the distributed processing, the registration of the excess terminals MT are deleted, thereby establishing some leeway to enable another group to register the slave terminals MT into the main group thereof.

According to the data processing method, the registration of a slave terminal MT having data in the distributed shared memory area Md is not deleted from the main group, enabling a situation to be prevented where intermediate process results cannot be collected consequent to the intermediate process results being saved in the distributed shared memory area Md of the slave terminal MT whose registration has been deleted from the main group.

According to the data processing method, if the size of the memory M used by one process among the processes included in the distributed processing is greater than the size of the shared memory Mc, the distributed shared memory areas Md of the terminals MT in the group are released. Thus, when a size that can save intermediate process results cannot be established as the shared memory Mc, the distributed shared memory areas Md are released, enabling a work area for the slave terminals MT to be established and the efficiency of the processes to be improved.

According to the data processing method, if a deterioration in the communication capability of a slave terminal MT has been detected, the registration of the slave terminal MT whose communication capability has deteriorated is deleted from the main group. Thus, a slave terminal MT whose communication capability has deteriorated and is at risk of becoming unable to transmit or receive data is excluded from the group, enabling the distributed processing to be stabilized and executed.

According to data processing method, if intermediate process results have been returned from a slave terminal MT that has suspended the distributed processing, the registration of the slave terminal MT that has returned the intermediate process results is deleted from the main group, thereby enabling a slave terminal MT that has suspended distributed processing to be excluded from the group and enabling the distributed processing to be continued using the returned intermediate process results.

According to the data processing method, if the distributed shared memory area Md is not being used, the data in the distributed shared memory area Md is collected, thereby enabling intermediate process results of the distributed processing to be collected and the distributed processing to be continued.

The data processing method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

According to one aspect of the embodiment, a concentration of load at a particular terminal during distributed processing by a group of mobile terminals can be prevented and the efficiency of the distributed processing can be improved.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data processing method that is executed by a processor, the data processing method comprising:
detecting an addition request to add a first device to a first group that includes a plurality of devices;
registering the first device into a main group in which devices of the first group are registered, the first device being registered when the first device does not belong to a second group that is different from the first group;
registering the first device into a subgroup, when the first device belongs to the second group; and
performing by the devices registered in the main group, distributed processing that includes a plurality of tasks.

2. The data processing method according to claim 1, wherein
the detecting includes detecting an addition request to add a second device to the first group,
the data processing method further comprises comparing a first count that is a count of the devices and a second count that is a count of the tasks, and
registering based on a comparison result, the second device into any one among the main group and the subgroup.

3. The data processing method according to claim 2, wherein
the registering of the second device includes registering the second device into the subgroup, when the first count is at least equal to the second count, and
the registering of the second device includes registering the second device into the main group, when the first count is less than the second count.

4. The data processing method according to claim 1, further comprising
registering in a master terminal of the subgroup, a synchronization request that is for the first device and from another device included in the second group, when the first device is registered in the subgroup.

5. The data processing method according to claim 1, further comprising
notifying a base station of registration or no-registration to the main group.

6. The data processing method according to claim 1, further comprising
deleting from the main group and when the first count is greater than the second count, registration of a third device to which no task among the tasks has been assigned.

7. The data processing method according to claim 6, wherein
the deleting includes refraining from deleting from the main group, the registration of the third device, when a memory area that is set in the third device and is part of shared memory that is shared by the devices is being used.

8. The data processing method according to claim 6, further comprising
releasing setting of the shared memory, when a size of memory used by tasks among the tasks is greater than a size of shared memory that is shared by the devices.

9. The data processing method according to claim 1, wherein
the deleting includes deleting from any one among the main group and the subgroup, registration of a fourth device, when any one among deterioration of a communication capability of the fourth device that is registered in the main group is detected and execution results of a task of the fourth device is acquired.

10. The data processing method according to claim 9, further comprising
collecting data that is in the memory area, when the memory area that is set in the fourth device and part of shared memory that is shared by the devices, is being used.

11. The data processing method according to claim 9, further comprising
releasing setting of the shared memory, when a size of memory used by tasks among the tasks is greater than a size of shared memory that is shared by the devices.

12. The data processing method according to claim 6, further comprising
notifying a base station of deletion of registration from the main group.
